(19) United States
(12) Patent Application Publication
(10) Pub. No.: US 2024/0403634 A1
(43) Pub. Date: Dec. 5, 2024

(54) SAVING PRODUCTION RUNS OF A FUNCTION AS UNIT TEST AND AUTOMATIC OUTPUT REGENERATION

(71) Applicant: Palantir Technologies Inc., Denver, CO (US)

(72) Inventors: Matthew Hawes, Denver, CO (US); Ankit Shankar, San Francisco, CA (US); Morten Telling, Copenhagen (DK); Adil Majid, New York, NY (US); Jack Dobson, New York, NY (US)

(21) Appl. No.: 18/676,339

(22) Filed: May 28, 2024

Related U.S. Application Data
(60) Provisional application No. 63/505,227, filed on May 31, 2023.
(60) Provisional application No. 63/583,484, filed on Sep. 18, 2023.
(60) Provisional application No. 63/505,218, filed on May 31, 2023.
(60) Provisional application No. 63/579,898, filed on Aug. 31, 2023.

(51) Int. Cl. G06N 3/08

(52) U.S. Cl. CPC G06N 3/08

(57) ABSTRACT

An artificial intelligence system can be used to respond to natural language inputs. The AI System may, for example, receive a first user input for a LLM, generate a first prompt based on the first user input, transmit the first prompt to an LLM, receive an output from the LLM, and evaluate the output from the LLM with reference to one or more validation tests. Responsive to determining that the output from the LLM is not validated, generate a second prompt for the LLM, where the second prompt indicates at least an aspect of the output that caused the output to not be evaluated (e.g., a portion of the output that may need to be updated or corrected), transmit the second prompt to the LLM, and receive an updated output from the LLM. The AI system can include an application for testing functions that utilize interactions with language models.

### FIELD

Implementations of the present disclosure relate to systems and techniques for improving user interactions with computer-based models. More specifically, implementations of the present disclosure relate to computerized systems and techniques that improve user interactions with large language models (“LLMs”) and interactions of LLMS with technical systems through analysis, updating, supplementing, summarizing, etc. natural language prompts from users, as well as responses from the LLMs. The present disclosure also relates to computerized systems and techniques for automatically validating and regenerating outputs of large language models.

### BACKGROUND

Computers can be programmed to perform calculations and operations utilizing one or more computer-based models. For example, language models can be utilized to provide and/or predict a probability distribution over sequences of words.

Large language models are opaque, imprecise, and inconsistent in their replies, which make them good conversationalists but also difficult to debug when they are expected to perform consistently. Further, complex calls to an LLM can involve multiple back-and-forth responses, where previous responses may be used in downstream prompts, which may further complicate the consistency and predictability of results.

### SUMMARY

The systems, methods, and devices described herein each have several aspects, no single one of which is solely responsible for its desirable attributes. Without limiting the scope of this disclosure, several non-limiting features will now be described briefly. For ease of discussion, certain embodiments described herein refer to regeneration and/or correction of an output by an LLM. Because a typical LLM is stateless (e.g., doesn't remember previous prompts or replies provided to a particular user), this “regeneration and/or correction” typically refers to a process of generating an updated prompt by the AIS, sending the updated prompt to the LLM, and receiving a “regenerated and/or corrected” output from the LLM. As discussed further herein, the updated prompt may include some or all of the original prompt, conversation history, and/or other context, with some adjustment intended to improve a subsequent output of the LLM.

The present disclosure describes examples of an artificial intelligence system (“AIS” or “system”) that implements systems and methods for validating, regenerating and/or correcting outputs of language models, or more specifically, LLMs. The present disclosure further includes various processes, functionality, and interactive graphical user interfaces related to the system. According to various implementations, the system (and related processes, functionality, and interactive graphical user interfaces), can advantageously automatically validate the output of LLMs and, when validation passes, present the output of LLMs (and/or some representation of the output, such as a portion of the output that is parsed and/or reformatted for improved understanding by the user) to users through user interfaces. But when validation fails, the system may prompt LLMs to regenerate the output (e.g., by generating and sending an updated prompt to the LLM) and refrain from presenting the output of LLMs to users until validation passes. Advantageously, LLM hallucinations or errors may be resolved by the system through the automatic validation, regeneration, and/or correction on the output of LLMs, without further input by the user in some implementations. Additionally, erroneous or inferior output of LLMs may be withheld from being presented to users. A validation error may trigger an alert to a user and/or may be used in generating new or updated validation rules, updating user input provided to the LLM, and/or other updates to the systems that may result in fewer and/or more meaningful validation error detection in the future.

The present disclosure also relates to systems and techniques that improve user interactions with LLMs through testing functions that utilize interactions with LLMs. Some implementations of the present disclosure relate to computerized systems and techniques for chaining language models with other types of functions.

The present disclosure includes a system, methods, and software (among other disclosed features) for generating and/or utilizing validation tests (also referred to as “unit tests”) for use in testing functions that utilize LLMs (generally referred to herein as “the system”). The present disclosure further includes various processes, functionality, and interactive graphical user interfaces related to the system. According to various implementations, the system (and related processes, functionality, and interactive graphical user interfaces), can advantageously provide the ability to save data associated with execution of a function (also referred to as a “production run”), such as information included in an execution log, as a validation test. A validation test can be used to test interactions with one or more LLMs to determine if the function, and/or an update to the function, is performing as desired. The system can advantageously determine permissions for the validation test and/or the function. The system can advantageously enable users to test functions that chain LLMs together with other types of operations, such as, for example, specialized operations, machine learning models, optimization models, data lakes/sources of truth (such as an ontology of data objects), and/or the like.

The system may include functions that indicate interactions with an LLM. The functions may utilize interactions LLMs to perform an identified task included in the function. The identified task can be represented and/or defined by a natural language description of the task. For example, a function may utilize interactions with LLMs to perform the task of “scheduling maintenance for the oldest piece of equipment.” The task may be defined by a user, elsewhere in the system, or by other components outside of the system, such as by an LLM or other model. A function may include information that can be shared with an LLM to accomplish the task. A function may include various other function inputs such as tools, tool parameters, object types, and/or data inputs. A function may utilize the function inputs to generate prompts for LLMs based on the task and/or information received from an LLM or other model. The prompts may include natural language instructions for an interaction with an LLM that includes information that is derived from the function inputs. For example, a function may utilize function inputs to generate a prompt based on the task of “scheduling maintenance for the oldest piece of equipment” that includes information from data inputs associated with scheduling maintenance, equipment information, and/or other data needed to perform the task or identify further tasks. Upon executing a function, the system may receive responses from LLMs based on the prompt. The responses from the LLMs may contain a result for the task and/or another step or subtask for the function to use to generate another prompt for the LLMs. For example, the responses from an LLM may contain results for the task, such as information that allows the application to schedule maintenance for a piece of equipment, or a request for more information, such as a request for information from a data input that has equipment ages.

A function may be associated with one or more execution logs. As described herein, an execution log may include a record of the various function inputs, prompts, and responses received from an LLM during the execution of a function. An execution log may record a single interaction of the system and an LLM during the execution of the function or may record multiple interactions of the system and an LLM during the execution of the function. When the execution log includes multiple interactions with an LLM, the execution log may also include sub-execution logs of the individual interactions with the LLM.

In some instances, the system may generate an execution log in response to a function failure, e.g., a production run of the function may not provide the expected result. For example, the system may generate an execution log in response to a function failing one or more validation tests. In other instances, the system may generate an execution log each time a function is executed. An execution log may include a record of every function input, prompt, and response received from an LLM during the execution of a function or may include a reduced record. For example, an execution log may include a reduced record of only the function inputs, prompts and responses received from an LLM associated with a failed execution of the function.

The system may utilize validation tests (otherwise referred to a “unit tests”) to analyze functions and responses from an LLM. A validation test may be configured to test an entire function or components of a function. A validation test can include fixed validation test inputs for some of the function inputs and validation test results. The validation test inputs may be predetermined values for some of the function inputs (e.g., the task description, data inputs, tools, etc.). The validation test results can be a predetermined outcome that is expected to occur given the validation test inputs.

To determine if a function passes a validation test, the system can compare an outcome from the execution of the function (e.g., a prompt, a response received from an LLM, a tool call, etc.) to the validation test result and determine if the outcome and the validation test result are equivalent. In some embodiments, a user compares the outcome and the validation test result and indicates if the outcome and validation test results are equivalent. In some embodiments, the outcome and the validation test results are compared using one or more models. For example, an LLM may be asked to rate how similar the outcome is to the validation test result.

In a nonlimiting example, a function may be set up to perform the task of parsing a database and scheduling appointments based on the text found in the database. Because the function utilizes nondeterministic LLMs to perform portions of the task, it is possible that the function may result in false positives. For example, the function may schedule an appointment (e.g., an online or in-person appointment for a service industry, such as medical, health and beauty, retail, etc.) that was not called for in the database. In this example, a validation test may be configured to test if variations of the natural language description of the task prevent these false positives. The validation test input may include a set of text files that do not contain text that should cause the function to schedule an appointment. The validation test result may be a predetermined outcome that no appointment is scheduled by the function. The natural language description of the task can then be varied, and the system can determine whether each variation passes the validation test. For example, the language description, “Schedule an appointment based on the attached database” may fail the validation test due to a hallucination from the LLM, while the language description, “Attached is a database. If any text file asks for an appointment, return the time and location indicated in the text file. If no text file asks for an appointment, return ‘no appointment requested’” may pass the validation test.

While the above example identifies input data as the validation test input and the natural language description of the task as variable, a validation test can have other configurations. For example, a particular natural language description of the task may be a validation test input while data inputs are variable. Any combination of the task description and function inputs may be included as validation test inputs. For example, a natural language description of the task, a data input, and a tool may all be a validation test input for a particular validation test. Further, a type of function input may include some validation test inputs and some variable inputs. For example, a set of data inputs may be included as validation test inputs while another set of data inputs may vary based on the execution of the function. Any function input that is not a validation test input may be varied so the system can determine if the variation passes the validation test.

When an output of an LLM is used to generate database queries or to perform other computing operations using one or more tools, the use of validation tests in accordance with the disclosure can improve the accuracy of the LLM initiated computing operations. This is advantageous as it reduces the processing cost resulting from unsuccessful applications of computing tasks generated based on unvalidated LLM outputs. The use of validation of LLM outputs in combination with output correction based on the validation tests can achieve successful performance of computing operations that would not have been possible without validation and correction. For example, when the output of the LLM comprises a query to a database, the use of validation tests and correction of the LLM outputs to generate updated outputs allows the database query to be structured in a form that successfully identifies and retrieves data that would be inaccessible based on the original query.

A validation test may be utilized to test an entire function execution or portions of the function execution. For example, a validation test may be configured to test the prompt generation portion of a function. In this example, the validation test may include a prompt as the validation test result that should be generated based on the validation test input.

A validation test can include more than one interactions with an LLM. For example, the system may execute the function and generate a prompt for an LLM from the validation test inputs and variable inputs of the validation test and use the response of the LLM to generate another prompt for the LLM. This process may repeat until the system determines the response of the LLM should be compared to the validation test result. A validation test may include multiple nested validation tests. For example, a validation test may be configured to test multiple interactions between the system and an LLM. In this example, the validation test may have an overall validation test with validation test inputs and a validation test result for the overall function with sub-validation test that test individual interactions and/or portions of the individual interactions. The system can determine if each validation test in a nested validation test passes for a function execution.

A validation test may be based in part on the function being tested by the validation test. For example, a previous execution of the function being tested may be converted into a validation test. A validation test may also be based in part on a different functions and/or on user definitions of portions of the validation test.

To convert a function into a validation test, a user may select one or more execution logs of the function to convert into the validation test. Once one or more execution logs are selected to convert into a unit test, the system may determine the validation test inputs and the validation test results. To determine the validation test inputs of a validation test, the system may save a portion of the function inputs in the execution log. For example, the system may save a portion of the description of the tasks and/or the tools, tool parameters, object types, and/or data inputs used in the execution log as validation test inputs. The system may receive user input selecting the validation test inputs from the execution log. For example, a user may select a portion of the description of the tasks and/or the tools, tool parameters, object types, and/or data inputs used in the execution log as the validation test inputs of a validation test.

To determine the validation test results for the validation test, the system may determine a result that should occur in the system based on validation test inputs. For example, the system may determine for a task of “scheduling maintenance for the oldest piece of equipment” that the system should schedule maintenance at a time for a specific piece of equipment. In some embodiments, the system determines the validation test results for a validation test based on one or more user inputs entering a desired result.

A function may be converted into a validation test based on a failed execution of the function. For example, a function to perform the task of “scheduling maintenance for the oldest piece of equipment” may not schedule an appointment or schedule an incorrect appointment based on the function inputs. In this example, the execution logs of the function may be converted into one or more validation tests to analyze the function and the function may be modified until the function can reliably pass the one or more validation tests. In some embodiments, a function must pass each validation test assigned to the function before the function can be utilized in a non-testing environment or may be removed from a non-testing environment in response to failing a validation test.

The functions, function inputs, and/or execution logs may have sets of rules, such as permissions, constraints, qualifications, authorizations, security markings, access controls, and the like (generally referred to herein as “permissions”) that govern the access to each function, function inputs, or execution log. In order to access or execute a function, function inputs, and/or execution log, a user may need to have the permissions associated with the function, function inputs, or execution log. For example, a particular data input may contain confidential information. In this example the particular data input may be associated with a permission such that only a user with the permission can access or cause the system to access the confidential information in the data input or view the data input in the execution log.

A permission may be associated with different scopes. For instance, a permission can be applied to portions of data inputs (e.g., a data source that is accessed via a tool), such as individual data values, ranges of data values, columns of data values, rows of data values, tabs, and other portions of a data input or a combination thereof. A permission can also be applied to an entire data input or multiple data inputs. In some embodiments, a permission may be applied to one or more entire data inputs or one or more portions of data inputs. Similarly, permission can be applied to individual tools or object types or multiple functions or object types, classes of functions or object types, libraries of functions, database of object types, and the like.

The permissions applied to the functions, function inputs, and/or execution logs used in the execution of a function may be applied to one or more responses received from an LLM. In this way, all of the permissions required to access the functions and/or function inputs used to generate a prompt are also required to access the response to the prompt. The permissions applied to the functions and/or function inputs used in the execution of the function may be tracked and applied to portions of the execution log. As such, all, or a portion, of an execution log may be restricted from a user without the required permissions. For example, a user without the required permissions may be restricted or otherwise prevented from viewing portions of function inputs, prompts, and/or LLM responses in an execution log.

A user without the required permissions may be prevented from executing a function. For example, a user without the permissions to a function or function input used in execution the function may be prevented from executing the function.

When a function is converted into a validation test, any permissions associated with the function or function input may be applied to the validation test. As such, secured information used in the execution of the function remains secured in the validation test. For example, the permissions on the function or function inputs used in the execution of a function can be applied to the validation test inputs, the validation test results, and/or any intermediate data inputs, prompts, and LLM responses of a validation test.

In some embodiments, a user may request one or more permissions associated with a validation test to be removed or temporarily disabled. For example, a system developer may be using a validation test to test a modification of a function. In this example, the system developer may receive an indication that the validation test is failing but not have the required permissions to view the data inputs, the prompt, and/or the LLM responses for the validation test. As such, the system developer may have difficulty determining why the validation test is failing. In this example, the system developer may request that one or more permissions be removed or temporarily disabled so the system developer can view the restricted information. In some embodiments, when the system receives a request that a permission is to be removed or temporarily disabled, the system requests confirmation for a user with the authority over the permission (e.g., the owner of the confidential information).

Various embodiments of the present disclosure provide improvements to various technologies and technological fields. For example, as described above, various embodiments of the present disclosure may advantageously improve the performance and accuracy of an artificial intelligence system enabling users to test and improve how the system interacts with LLMs.

Additionally, various embodiments of the present disclosure are inextricably tied to computer technology. In particular, various embodiments rely on detection of user inputs via graphical user interfaces, calculation of updates to displayed electronic data based on those user inputs, automatic processing of related electronic data, application of language models and/or other artificial intelligence, and presentation of the updates to displayed information via interactive graphical user interfaces. Such features and others (e.g., processing and analysis of large amounts of electronic data) are intimately tied to, and enabled by, computer technology, and would not exist except for computer technology. For example, the interactions with displayed data described below in reference to various embodiments cannot reasonably be performed by humans alone, without the computer technology upon which they are implemented. Further, the implementation of the various embodiments of the present disclosure via computer technology enables many of the advantages described herein, including more efficient interaction with, and presentation of, various types of electronic data.

According to various implementations, large amounts of data are automatically and dynamically calculated interactively in response to user inputs, and the calculated data is efficiently and compactly presented to a user by the system. Thus, in some implementations, the user interfaces described herein are more efficient as compared to previous user interfaces in which data is not dynamically updated and compactly and efficiently presented to the user in response to interactive inputs.

Further, as described herein, the system may be configured and/or designed to generate user interface data useable for rendering the various interactive user interfaces described. The user interface data may be used by the system, and/or another computer system, device, and/or software program (for example, a browser program), to render the interactive user interfaces. The interactive user interfaces may be displayed on, for example, electronic displays (including, for example, touch-enabled displays).

Additionally, it has been noted that design of computer user interfaces that are useable and easily learned by humans is a non-trivial problem for software developers. The present disclosure describes various implementations of interactive and dynamic user interfaces that are the result of significant development. This non-trivial development has resulted in the user interfaces described herein which may provide significant cognitive and ergonomic efficiencies and advantages over previous systems. The interactive and dynamic user interfaces include improved human-computer interactions that may provide reduced mental workloads, improved decision-making, reduced work stress, and/or the like, for a user. For example, user interaction with the interactive user interface via the inputs described herein may provide an optimized display of, and interaction with, models and model-related data, and may enable a user to more quickly and accurately access, navigate, assess, and digest the model-related data than previous systems.

Further, the interactive and dynamic user interfaces described herein are enabled by innovations in efficient interactions between the user interfaces and underlying systems and components. For example, disclosed herein are improved methods for validating, regenerating and/or correcting outputs of language models, or more specifically, large language models. According to various implementations, the system (and related processes, functionality, and interactive graphical user interfaces), can advantageously automatically validate the output of LLMs and, when validation passes, present the output of LLMs to users through user interfaces. But when validation fails, the system may prompt LLMs to regenerate the output and refrain from presenting the output of LLMs to users until validation passes. As such, erroneous or inferior output of LLMs may be withheld from being presented to users. A validation error may trigger an alert to a user and/or may be used in generating new or updated validation rules, updating user input provided to the LLM, and/or other updates to the systems that may result in fewer and/or more meaningful validation error detection in the future.

Thus, various implementations of the present disclosure can provide improvements to various technologies and technological fields, and practical applications of various technological features and advancements. For example, as described above, existing computer-based model management and integration technology is limited in various ways, and various implementations of the disclosure provide significant technical improvements over such technology. Additionally, various implementations of the present disclosure are inextricably tied to computer technology. In particular, various implementations rely on operation of technical computer systems and electronic data stores, automatic processing of electronic data, and the like. Such features and others (e.g., processing and analysis of large amounts of electronic data, management of data migrations and integrations, and/or the like) are intimately tied to, and enabled by, computer technology, and would not exist except for computer technology. For example, the interactions with, and management of, computer-based models described below in reference to various implementations cannot reasonably be performed by humans alone, without the computer technology upon which they are implemented. Further, the implementation of the various implementations of the present disclosure via computer technology enables many of the advantages described herein, including more efficient management of various types of electronic data (including computer-based models).

Various combinations of the above and below recited features, embodiments, and aspects are also disclosed and contemplated by the present disclosure. Additional embodiments of the disclosure are described below in reference to the appended claims, which may serve as an additional summary of the disclosure.

In various implementations, systems and/or computer systems are disclosed that comprise a computer-readable storage medium having program instructions embodied therewith, and one or more processors configured to execute the program instructions to cause the systems and/or computer systems to perform operations comprising one or more aspects of the above- and/or below-described implementations (including one or more aspects of the appended claims).

In various implementations, computer-implemented methods are disclosed in which, by one or more processors executing program instructions, one or more aspects of the above- and/or below-described implementations (including one or more aspects of the appended claims) are implemented and/or performed.

In various implementations, computer program products comprising a computer-readable storage medium are disclosed, wherein the computer-readable storage medium has program instructions embodied therewith, the program instructions executable by one or more processors to cause the one or more processors to perform operations comprising one or more aspects of the above- and/or below-described implementations (including one or more aspects of the appended claims).

### BRIEF DESCRIPTION OF THE DRAWINGS

The following drawings and the associated descriptions are provided to illustrate embodiments of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1A is a schematic block diagram illustrating an example automatic correction system in an example computing environment.

FIG. 1B depicts an example block diagram of the automatic correction system of FIG. 1A, where the automatic correction system can be utilized to automatically validate and regenerate output from language models.

FIGS. 2A-2B depict example interactions for automatically validating and regenerating output from language models on the automatic correction system of FIG. 1B.

FIGS. 3A-3B is an example flow chart depicting an example routine for validating and regenerating output from a LLM as part of the automatic correction system of FIG. 1A or FIG. 1B in accordance with some embodiments of the present disclosure.

FIG. 4 is a flow chart depicting an example routine for generating one or more validation tests for validating an output from a LLM as part of the automatic correction system of FIG. 1A or FIG. 1B in accordance with some embodiments of the present disclosure.

FIGS. 5, 6, 7, 8, and 9 are illustrations of example user interfaces of the automatic correction system of FIG. 1A or FIG. 1B in accordance with some embodiments of the present disclosure.

FIG. 10 is a block diagram of an example computer system consistent with various implementations of the present disclosure.

FIG. 11A is a block diagram illustrating an example artificial intelligence system in communication with various devices to orchestrate fulfillment of a user prompt.

FIG. 11B is a flowchart illustrating an example method for interactions with an LLM according to various embodiments.

FIGS. 12A and 2B are flowcharts illustrating example methods for testing functions that utilize interactions with a large language model according to various embodiments.

FIG. 13 is a flowchart illustrating an example method for generating a validation test from a function according to various embodiments.

FIG. 14 is a flowchart illustrating an example method for restricting a user based on permissions according to various embodiments.

FIGS. 15, 16 and 17 illustrate example user interfaces of an artificial intelligence system according to various embodiments.

### DETAILED DESCRIPTION

Although certain embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

To facilitate an understanding of the systems and methods discussed herein, several terms are described below. These terms, as well as other terms used herein, should be construed to include the provided descriptions, the ordinary and customary meanings of the terms, and/or any other implied meaning for the respective terms, wherein such construction is consistent with context of the term. Thus, the descriptions below do not limit the meaning of these terms, but only provide example descriptions.

Model: any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, machine learning (“ML”) models, multimodal models (e.g., models or combinations of models that can accept inputs of multiple modalities, such as images and text), and/or the like.

Language Model: any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language responses based on the text on which the model is trained. A language model may include an n-gram, exponential, positional, neural network, and/or other type of model.

Large Language Model (“LLM”): any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. LLMs may work by taking an input text and repeatedly predicting the next word or token (e.g., a portion of a word, a combination of one or more words or portions of words, punctuation, and/or any combination of the foregoing and/or the like). An LLM may comprise a NN trained using self-supervised learning. An LLM may be of any type, including a Question Answer (“QA”) LLM that may be optimized for generating answers from a context, a multimodal LLM/model, and/or the like. An LLM (and/or other models of the present disclosure), may include, for example, a NN trained using self-supervised learning and/or semi-supervised learning, a feedforward NN, a recurrent NN, and/or the like. LLMs can be extremely useful for natural language processing, including receiving natural language prompts and providing natural language responses based on the text on which the model is trained. LLMs may not be data security—or data permissions-aware, because they generally do not retain permissions information associated with the text upon which they are trained. Thus, responses provided by LLMs are typically not limited to any particular permissions-based portion of the model.

While certain aspects and implementations are discussed herein with reference to use of a language model, LLM, and/or AI, those aspects and implementations may be performed by any other language model, LLM, AI model, generative AI model, generative model, ML model, NN, multimodal model, and/or other algorithmic processes. Similarly, while certain aspects and implementations are discussed herein with reference to use of a ML model, language model, or LLM, those aspects and implementations may be performed by any other AI model, generative AI model, generative model, NN, multimodal model, and/or other algorithmic processes.

In various implementations, the LLMs and/or other models (including ML models) of the present disclosure may be locally hosted, cloud managed, accessed via one or more Application Programming Interfaces (“APIs”), and/or any combination of the foregoing and/or the like. Additionally, in various implementations, the LLMs and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLAMA (Large Language Model Meta AI), and BigScience Large Open-science Open-access Multilingual Language Model (BLOOM).

Data Processing Service (or “Service” or “Plug-in”): receives and responds to requests for data and/or data processing. A Plug-in may be accessible via an API that is exposed to an Artificial Intelligence System (and/or other remote systems) and allows data processing requests to be received via API calls from those systems (e.g., an AIS). A few examples of services or plug-ins include a table search service, a filter service, an object search service, a text search service, or any other appropriate search service, indexing services, services for formatting text or visual graphics, services for generating, creating, embedding and/or managing interactive objects in a graphical user interface, services for caching data, services for writing to databases, an ontology traversing service (e.g., for traversing an ontology or performing search-arounds in the ontology to surface linked objects or other data items) or any other data retrieval, processing, and/or analysis function.

Prompt (or “Natural Language Prompt” or “Model Input”): a term, phrase, question, and/or statement written in a human language (e.g., English, Chinese, Spanish, etc.) that serves as a starting point for a language model and/or other language processing. A prompt may include only a user input or may be generated based on a user input, such as by a prompt generation module (e.g., of an artificial intelligence system) that supplements a user input with instructions, examples, and/or information that may improve the effectiveness (e.g., accuracy and/or relevance) of an output from the language model. A prompt may be provided to an LLM which the LLM can use to generate a response (or “model output”).

User Input (or “Natural Language Input”): a term, phrase, question, and/or statement written in a human language (e.g., English, Chinese, Spanish, etc.) that is provided by a user, such as via a keyboard, mouse, touchscreen, voice recognition, and/or other input device. User input can include a task to be performed, such as by an LLM, in whole or in part. User input can include a request for data, such as data accessed and/or processed by one or more services. User input can indicate one or more tools associated with the user request or task which may facilitate performing the task. User input can indicate one or more data object types associated with a tool. User input can indicate one or more actions associated with a tool. User input can include a user selection of a format for a response from an LLM. User input can include a user-defined variable to which a response may be saved.

Context: any information associated with user inputs, prompts, responses, etc. that are generated and/or communicated to/from the user, the artificial intelligence system, the LLM, the data processing services, and/or any other device or system. For example, context may include a conversation history of all of the user inputs, prompts, and responses of a user session. Context may be provided to an LLM to help an LLM understand the meaning of and/or to process a prompt, such as a specific piece of text within a prompt. Context can include information associated with a user, user session, or some other characteristic, which may be stored and/or managed by a context module. Context may include all or part of a conversation history from one or more sessions with the user (e.g., a sequence of user prompts and orchestrator selector responses or results, and/or user selections (e.g., via a point and click interface or other graphical user interface). Thus, context may include one or more of: previous analyses performed by the user, previous prompts provided by the user, previous conversation of the user with the language model, schema of data being analyzed, a role of the user, a context of the data processing system (e.g., the field), and/or other contextual information.

A context module may provide all or only a relevant portion of context to a selection module for use in selecting one or more plug-ins and/or service orchestrators (e.g., configured to generate requests to plug-ins) for use in generating a properly formatted service request. Context can include tool information. Context can include tool implementation examples. In some embodiments, context may include identification of services and parameters of prior operations, but not underlying data that was accessed or retrieved by the service (e.g., use of graph visualization service and graph parameters without indicating the data illustrated in the graph). In some embodiments, context may include some or all of the underlying data accessed or retrieved by the service.

Tool: any set of logic or rules that can be provided to an LLM that the LLM can use to obtain additional information, such as by generating a request for access to additional data via a plug-in. Thus, a tool can be used by an LLM to generate requests (that may be fulfilled by the AIS) to perform operations such as querying datasets, processing data including filtering or aggregating data, writing to datasets (e.g., adding or updating rows of a table, editing or updating an object type, updating parameter values for an object instance, generating a new object instance), implementing integrated applications (e.g., an email or SMS application), communicating with external application programming interfaces (APIs), and/or any other functions that communicate with other external or internal components. Example tools include ontology function tool, date/time tool, query objects tool, calculator tool, and apply action tool. Tools, or the set of logic they comprise for performing one or more operations, may be defined by a system, external database, ontology and/or a user.

Tool Information: can include information associated with a tool that is provided to an LLM and is usable to implement the tool functionality. Tool information can indicate how data is structured, such as in an ontology. Tool information can indicate properties associated with a particular data object type, such as a data object type associated with a selected tool. Tool information can include instructions for implementing a tool. Tool information can include instructions for generating a tool call to use the tool, including instructions for formatting a tool call. In some implementations, tool information can comprise tool implementation examples for executing one or more tool operations which can include pre-defined examples, user-selected examples, user-generated examples, and/or examples that are automatically dynamically configured based on context.

Ontology: stored information that provides a data model for storage of data in one or more databases and/or other data stores. For example, the stored data may include definitions for data object types and respective associated property types. An ontology may also include respective link types/definitions associated with data object types, which may include indications of how data object types may be related to one another. An ontology may also include respective actions associated with data object types or data object instances. The actions may include defined changes to values of properties based on various inputs. An ontology may also include respective functions, or indications of associated functions, associated with data object types, which functions may be executed when a data object of the associated type is accessed. An ontology may constitute a way to represent things in the world. An ontology may be used by an organization to model a view on what objects exist in the world, what their properties are, and how they are related to each other. An ontology may be user-defined, computer-defined, or some combination of the two. An ontology may include hierarchical relationships among data object types.

Data Object (or “Object”): a data container for information representing a specific thing in the world that has a number of definable properties. For example, a data object can represent an entity such as a person, a place, an organization, a market instrument, or other noun. A data object can represent an event that happens at a point in time or for a duration. A data object can represent a document or other unstructured data source such as an e-mail message, a news report, or a written paper or article. Each data object may be associated with a unique identifier that uniquely identifies the data object. The object's attributes (also referred to as “contents”) may be represented in one or more properties. Attributes may include, for example, metadata about an object, such as a geographic location associated with the item, a value associated with the item, a probability associated with the item, an event associated with the item, and so forth.

Object Type: a type of a data object (e.g., person, event, document, and/or the like). Object types may be defined by an ontology and may be modified or updated to include additional object types. An object definition (e.g., in an ontology) may include how the object is related to other objects, such as being a sub-object type of another object type (e.g., an agent may be a sub-object type of a person object type), and the properties the object type may have.

In various implementations, systems and/or computer systems are disclosed that comprise a computer readable storage medium having program instructions embodied therewith, and one or more processors configured to execute the program instructions to cause the systems and/or computer systems to perform operations comprising one or more aspects of the above- and/or below-described implementations (including one or more aspects of the implementations described above).

In various implementations, computer-implemented methods are disclosed in which, by one or more processors executing program instructions, one or more aspects of the above- and/or below-described implementations (including one or more aspects of the implementations described above) are implemented and/or performed.

In various implementations, computer program products comprising a computer readable storage medium are disclosed, wherein the computer readable storage medium has program instructions embodied therewith, the program instructions executable by one or more processors to cause the one or more processors to perform operations comprising one or more aspects of the above- and/or below-described implementations (including one or more aspects of the implementations described above).

### Overview Of Automatic Output Regeneration And Correction For LLMs

LLMs typically have no built-in validation and thus may be prone to hallucinate (e.g., generate factually incorrect or nonsensical information) in their output. “Reflective” prompting (also referred to as “reflection” or “reflexion”) may be utilized in an effort to have the LLM to “check its own work.” For example, a reflective prompt may simply include the conversation history with an added questions/instruction, such as “is the output reasonable”, “check the validity of the provided output,” or similar. Yet, reflective prompting is typically conducted generically to provide inexact prompt for LLMs to improve their output, which may result in unsatisfactory output correction. Additionally, human intervention may be involved when performing “reflective” prompting. More specifically, developers of LLMs may intervene to prompt LLMs to regenerate and correct their outputs, thereby increasing the complexity of the development and improvement of LLMs.

As also noted above, the present disclosure describes examples of an artificial intelligence system (“AIS” or “system”) that implements systems and methods for validating, regenerating and/or correcting outputs of language models, or more specifically, LLMs. The present disclosure further includes various processes, functionality, and interactive graphical user interfaces related to the system. According to various implementations, the system (and related processes, functionality, and interactive graphical user interfaces), can advantageously automatically validate the output of LLMs and, when validation passes, present the output of LLMs (and/or some representation of the output, such as a portion of the output that is parsed and/or reformatted for improved understanding by the user) to users through user interfaces. But when validation fails, the system may prompt LLMs to regenerate the output and refrain from presenting the output of LLMs to users until validation passes. Advantageously, LLM hallucinations or errors may be resolved by the system through the automatic validation, regeneration, and/or correction on the output of LLMs, without further input by the user in some implementations. Additionally, erroneous or inferior output of LLMs may be withheld from being presented to users. A validation error may trigger an alert to a user and/or may be used in generating new or updated validation rules, updating user input provided to the LLM, and/or other updates to the systems that may result in fewer and/or more meaningful validation error detection in the future.

The system may automatically generate tests to validate outputs of LLMs. The tests may be generated based on various inputs, alone or in combination, that are received by LLMs. In some examples, tests may be generated based on a user input and/or a prompt to a LLM. For example, based on the user input and/or the prompt to the LLM, the system may infer the user's desired output type and incorporate the inferred desired output type as at least a portion of a validation test. Desired output type(s) can include, but not limited to, a string, text, binary, floating point, character, Boolean, timestamp, date, and/or the like. Optionally and/or alternatively, the system may solicit from the user a desired schema for output of the LLM and include the user-indicated schema as at least a portion of an automatically generated validation test. In other examples, the system may generate a validation test based on one or more tools that are selected by a user, e.g., to be utilized by the LLM for data processing. The tool may be a software (e.g., plugins) that may be executed by the system or be configured to communicate with the LLM as well as proprietary and/or publicly available data sources for consummating certain services, tasks or processing. In still other examples, the system may generate a test for validating output of a LLM based at least on specific data that an LLM output is expected to include. For example, if the LLM prompt requests an output that identifies an ontology data item, the system may generate a validity test that refers to and/or accesses ontology data to check validity of any possible ontology data items in the output. Thus, LLM output that will pass the test may be coherent or consistent with the ontology data.

The system may validate whether output of a LLM matches expectation of a user. When the output of a LLM passes a test, the system may then present the output of the LLM to the user through a user interface (and/or other input device). The user interface may be a graphical user interface (“GUI”) or other types of user interfaces that allow the user to interact with the system for achieving various objectives of the user through the utilization of the LLM. On the other hand, when the output of the LLM fails a validation test, the system may not present the output of the LLM to the user through the user interface. Instead, responsive to acknowledging the output of the LLM fails the validation test, the system may initiate a process to automatically re-prompt the LLM in an effort to output an updated output from the LLM that passes the validation test. If an updated output from the LLM, responsive to an updated LLM prompt, passes the validation test, the system may then provide the output of the LLM (e.g., some or all of the updated output and/or original output) to the user. Contrasting to typical processes or flows that require human intervention to some extent for correcting output of LLMs, the system advantageously reduces the complexity and labor needed for LLM output correction through automatic correction.

To automatically generate an updated LLM prompt with information usable by the LLM to provide a more suitable (e.g., valid) response, the system may notify the LLM that its output is in error or needs to be updated when output of the LLM fails the test generated by the system. Based on the automatically generated updated prompt (e.g., a second prompt) that may include most or all of the original prompt (e.g., a first prompt that is generated earlier in time than the second prompt) and some further instructions regarding a particular validation error, the LLM can provide a more accurate, useful and valid updated output. The system may further trigger the LLM to regenerate its output and provide guidance information for regeneration of LLM output. In some examples, the system may automatically generate prompt to the LLM for output regeneration. The prompt may be a natural language prompt that is generated based on data provided by a user interface of the system and/or other modules associated with the system. For example, the prompt may be the natural language prompt that is generated based on a user's manipulation of the user interface (e.g., dropdowns on a graphical user interface). As noted above, human intervention may not be needed when generating the natural language prompt so as to increase system efficiency as well as reduce complexity of LLM development. Additionally, rather than generating prompt that is generic or corresponding to a high-level description of aspects where output of the LLM needs correction, the system can provide for generation of detailed prompts to the LLM without requiring interventions from users or developers. The detailed prompt generated by the system for the LLM to regenerate output may be based on various data and/or instructions provided to the system and/or the LLM and may include, but not limited to, profile data associated with a user, context data associated with the user or a user session, ontology data, and the like. The system may then provide the detailed prompt to the LLM so that the LLM may correct its output “on the fly.” Advantageously, the detailed prompt generated by the system may allow the LLM to pinpoint the issues associated with its output, thereby enabling the LLM to more efficiently improve its output by reducing the number of iteration needed for output correction.

### Example Tests Generation Features

As noted above, the system can generate tests based on various inputs, alone or in combination, for validating output of LLMs under various kinds of conditions. The tests can be deterministic or heuristic, and/or the tests can be format-based or content-based. In some examples, the tests may include one or more rules that output of LLMs should adhere to in order to pass validation. For example, the rules may include syntax-based rules (e.g., grammatical checks on output of LLMs), semantic rules (e.g., for preventing certain ideas or concepts be grouped together to make output of LLM coherent to contexts), formality-based rules (e.g., checking whether a format of output of LLM is correct), character-based rules (e.g., checking the correctness and reasonableness of character(s) present in output of LLMs), object-based rules (e.g., checking whether object type(s) present in output of LLMs exist or not), tool-based rules (e.g., checking whether tool(s) utilized to generate output of LLM is intended based on user input or used correctly by the LLM or includes the function that the LLM tries to leverage), domain knowledge based rules (e.g., specifying certain business actions should not be executed in certain orders) or the like, and any combinations thereof. Additionally, the tests may specify positive limitation (e.g., specifying certain object types, tools or texts should appear in the output of LLMs) or negative limitation (e.g., specifying certain object types, tools or texts should not appear in the output of LLMs) on the output of LLMs. It should be noted that the rules used by the system to generate tests may vary depending on identity of the user. For example, the system may incorporate different rules to the tests for different users. As such, tests for validating output of the LLM may be based on “profile” or identity associated with a particular user, role, cohort, use case, organization, and/or context.

The system may optionally adjust how rigorous the tests are to increase or decrease the difficulty for output of LLMs to pass validation. In some examples, the system may incorporate new rules to the tests or increase number of existing rules to make it harder for output of LLMs to pass validation so as to increase the robustness of the tests. Additionally and/or alternatively, the tests can be heuristic, for example, through tying other models into at least a portion of the tests. More specifically, in some examples, the system may utilize a second LLM to check the output of a first LLM such that whether the output of the first LLM passes validation depends on the checking result from the second LLM. The second LLM may be a LLM that is specifically trained to spot errors of certain kinds (e.g., syntax or semantic errors). As another example, the second LLM may be designed to evaluate or analyze whether tones manifested in the output of the first LLM is appropriate in certain context (e.g., doing business transaction with clients). By incorporating some or all of the tests/rules discussed above, the system may validate output of LLMs on various levels as well as aspects.

### Example Output Validation Features

The system can further validate output of a LLM based on tests generated using techniques discussed above. To validate output of the LLM, the system may parse output of the LLM, for example, word by word, look for keywords or phrases in the output of the LLM, and apply the generated tests to the keywords or phrases, or other parts of the output. In some examples, the system may look at the word(s) after the keyword “tool” and apply tool-based rules to determine one or more validation tests to be applied to the output of the LLM. The output of the LLM may be validated when the word(s) after the keyword “tool” matches a tool specified in the tool-based rules. Besides applying tool-based rules to validate the output of the LLM, the system may optionally and/or alternatively apply other types of tests discussed above (e.g., syntax-based rules, object-based rules, semantic rules, formality-based rules, domain knowledge-based rules, or the like) to validate the output of the LLM.

The system may also adjust how tests are run to validate the output of the LLM. In some examples, the system may dictate that output of the LLM is validated when the output exactly matches with the rules contained within the tests used for validation. For example, the system may apply a syntax-based rule on the output of the LLM and only validates the output of the LLM when the output of the LLM literally matches what is specified in the syntax-based rule. In other examples, the system may run the tests used for validation without requiring exact matching between the output of the LLM and the tests. For example, the system may run the tests by checking for fuzzy matches (e.g., the output of the LLM does not include or mention some subject matters) between the LLM output and the tests. As such, the system may dynamically adjust the rigorousness of validation through, for example, affecting how many iterations may be needed before the output of the LLM can pass the tests used for validation.

### Example Output Correction Features

As noted above, if the output of a LLM does not pass validation, the system may notify the LLM that its output does not match expectation of a user and assist the LLM to correct its output (e.g., by generating an updated prompt that is less prone to causing the LLM to return another output that does not pass validation). Rather than providing a LLM with prompts that are generic in nature, the system may generate prompt(s) that includes specific information to more accurately identify aspects of current output that need correction. In some examples, the system may notify the LLM that the object type identified in the output of the LLM is invalid, and provide the LLM with an object type that is valid. In other examples, the system may notify the LLM that a tool that is identified in the output of the LLM is not available, and provide the LLM with one or more tools that are available and/or appropriate such that the LLM may generate an updated output that improves its earlier output through use of the available tools. In still other examples, the system may notify the LLM that an item the LLM is attempting to access does not exist, and provide the LLM with items that exist. Advantageously, compared with generic prompt given to the LLM for output correction, the more specific and/or focused prompts allow the LLM to provide an updated (or “corrected”) output more efficiently both in terms of time and resources needed for correction.

Additionally and/or alternatively, the system may automatically regenerate output of the LLM using techniques that do not require generating new prompts for feeding into the LLM. For example, the system may perform some form of intelligent sampling on tokens of the output of the LLM to correct the output without prompting the LLM to regenerate its output. Further, the system may notify LLM errors in its output and provide prompts to LLM for output regeneration by leveraging some techniques to streamline the notification and prompt generation process. In some examples, the system may utilize templates internal or external to the system for notifying the LLM which aspects of its output are in need of correction. The templates may include boilerplate texts and established formats for generating particular notification with enough detail about errors in the output of the LLM. As such, the output correction process may be more automated, thereby saving time and/or labor for LLM output correction.

In some examples, when the output of the LLM does not pass validation, the system may respond differently according to the errors or types of errors committed by the LLM. For example, when the output of the LLM does not pass validation because of some character-based rule (e.g., erroneously showing a character), the system may notify the LLM which character needs to be corrected and prompt the LLM to regenerate its output with corrected character. As another example, when the output of the LLM shows that the LLM tries to access data that do not exist, the system may not allow the LLM to automatically correct its output as such behavior on the part of the LLM may indicate that the LLM is hallucinating. In such situations, the system may alert a user or a designer of the system that the LLM tried to access data that do not exist or are unknown to the system. Advantageously, such alert to the user or the designer may be indicative of some inappropriate human operations to allow the user or the designer to adjust their inputs to the system and/or the LLM.

### Example User Interface Features

The system may further allow user to interact with the system through a user interface (e.g., a graphical user interface (“GUI”) or other types of user interfaces) to determine whether or not and how automatic LLM output regeneration is performed. In some examples, the system provides a user the option to enable or disable “reflective” prompting (e.g., through a user interface element such as a button on the user interface of the system) discussed above. When “reflective” prompting is disabled, output of the LLM may not be automatically regenerated by the system but the computational time and other computational resources needed for the user to receive output from the LLM may be less compared with when “reflective” prompting is enabled. Alternatively, when “reflective” prompting is enabled, output of the LLM may be automatically regenerated when the output is not validated such that the user may receive corrected output of the LLM. It should be noted that when “reflective” prompting is enabled, more computational resources (e.g., more iteration of computation) may be utilized by the system and/or the LLM to automatically regenerate output of the LLM.

### Example Large Language Model Functionality

According to various implementations, the system can incorporate and/or communicate with one or more LLMs to perform various functions. Such communications may include, for example, a context associated with an aspect or analysis being performed by the system, a user-generated prompt, an engineered prompt, prompt and response examples, example or actual data, and/or the like. For example, the system may employ an LLM, via providing an input to, and receiving an output from, the LLM. The output from the LLM may be parsed and/or a format of the output may be updated to be usable for various aspects of the system.

The system may employ an LLM to, for example, determine a modeling objective (e.g., based on one or more models and/or other information), identify additional models that may be related to the modeling objective, determine or generate a model location, determine or generate a model adapter configuration, determine or generate a sandbox or container implementation, and/or the like.

### Example System and Related Computing Environment

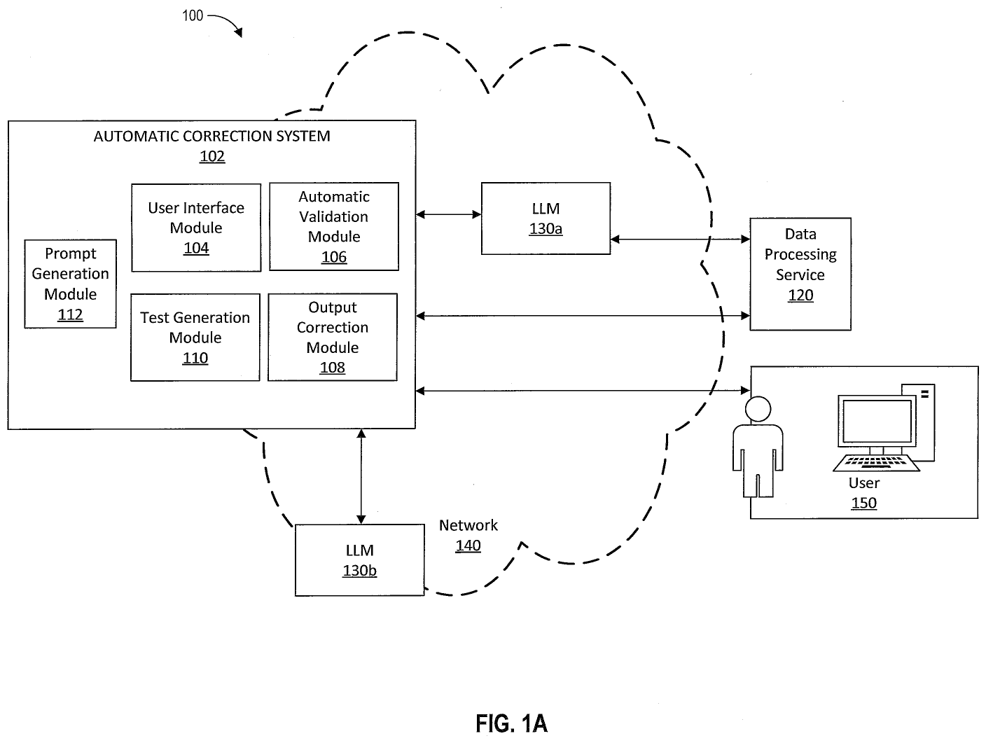

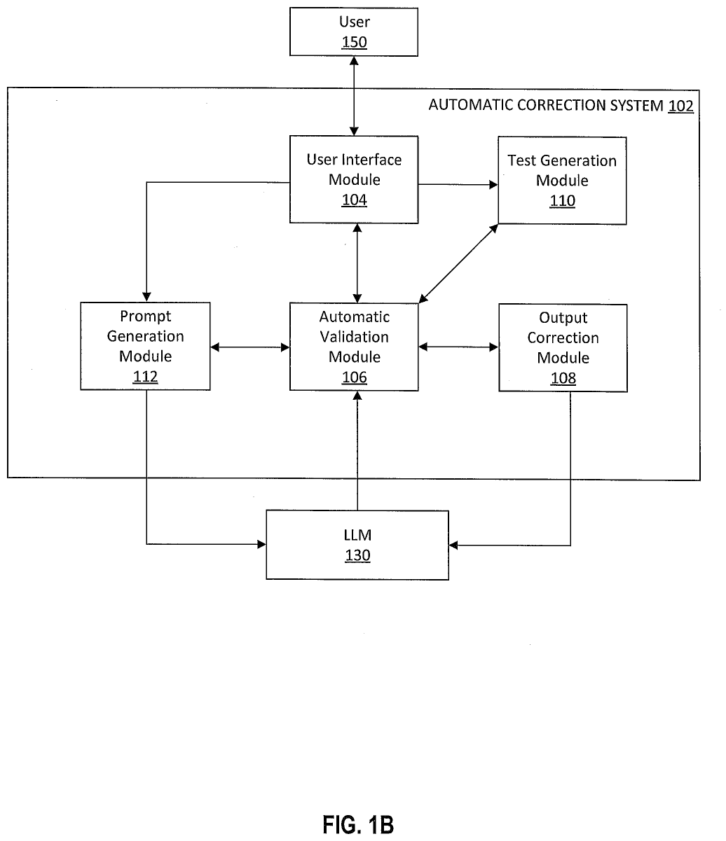

FIG. 1A illustrates an example computing environment 100 including an example automatic correction system 102 in communication with various devices to respond to a user prompt. The example computing environment 100 includes the automatic correction system 102, the LLM 130a, the LLM 130b, the network 140, the data processing service 120, and the user 150. In the example of FIG. 1A, the automatic correction system 102 comprises various modules, including a user interface module 104, a prompt generation module 112, test generation module 110, a automatic validation module 106, and a output correction module 108. In other embodiments, the automatic correction system 102 may include fewer or additional components.

In the example of FIG. 1A, the various devices are in communication via a network 140, which may include any combination of networks, such as one or more local area network (LAN), personal area network (PAN), wide area network (WAN), the Internet, and/or any other communication network. In some embodiments, modules of the illustrated components, such as user interface module 104, test generation module 110, automatic validation module 106, output correction module 108 and prompt generation module 112 of the automatic correction system 102, may communicate via an internal bus and/or via the network 140.

The user interface module 104 is configured to generate user interface data that may be rendered on a user 150, such as to receive an initial user input, as well as later user input that may be used to initiate further data processing. In some embodiments, the functionality discussed with reference to the user interface module 104, and/or any other user interface functionality discussed herein, may be performed by a device or service outside of the automatic correction system 102 and/or the user interface module 104 may be outside the automatic correction system 102. Example user interfaces are described in greater detail below.

The prompt generation module 112 is configured to generate a prompt to a language model, such as LLM 130a. As described in further detail below, the prompt generation module 112 may generate such a prompt based on data provided by the user interface module 104 (e.g., a user input) or other modules (e.g., the output correction module 108) of the automatic correction system 102.

In the example of FIG. 1A, a user 150 (which generally refers to a computing device of any type that may be operated by a human user) may provide a user input to the automatic correction system 102 indicating a natural language request for some data analysis to be performed. The user input along with other supplemental information or instructions, if any, may be provided to the prompt generation module 112 to generate a prompt that will be transmitted to the LLM 130a and/or 130b. In some embodiments, the user may select one or more object types to limit processing by the automatic correction system 102 to only those selected object types (which may increase speed and relevance of responses provided by the system), while in other embodiments the user may not provide any information except an initial input.

The test generation module 110 is configured to generate, based on various inputs, one or more tests (also referred to as “validation tests”) that will be utilized by the automatic validation module 106 to validate one or more output from the LLM 130a or 130b. In some examples, tests may be generated based on a user input or prompt to a LLM. For example, based on the user input or the prompt to the LLM, the system may infer the user's desired output type and incorporate the inferred desired output type as at least a portion of the tests. Desired output type(s) can include, but not limited to, a string, text, binary, floating point, character, Boolean, timestamp, date, and/or the like.

The automatic validation module 106 is configured to validate whether output of a LLM (e.g., LLM 130a or LLM 130b) matches expectation (e.g., of a user) based on the one or more validation tests generated by the test generation module 110. When the output of a LLM passes a test, the automatic validation module 106 may then cause the output of the LLM to be presented to the user 150 through the user interface module 104. On the other hand, when the output of the LLM fails the test, the automatic validation module 106 may prevent the output of the LLM from being presented to the user 150 through the user interface module 104, and/or may make the output of the LLM available in a debugger panel of the user interface. Responsive to acknowledging the output of the LLM fails the test, the automatic validation module 106 may trigger the output correction module 108 to automatically correct the output of the LLM, which may include causing the prompt generation module 112 to generate a new prompt for the LLM to generate an updated output. In some embodiments, the automatic validation module 106 may cause the updated output from the LLM be presented to the user 150 through the user interface module 104 only if the updated output passes the one or more validation tests.

The output correction module 108 is configured to facilitate automatic correction on the output of the LLM 130a or 130b if the output is not validated by the automatic validation module 106. In some embodiments, the output correction module 108 may provide specific information to prompt generation module 112 and cause the prompt generation module 112 to generate prompt(s) that includes the specific information to more accurately identify aspects of current output that need correction. Additionally and/or alternatively, the output correction module 108 may correct output of the LLM 130a or 130b using techniques that do not cause the prompt generation module 112 to generate new prompts for feeding into the LLM. For example, the output correction module 108 may perform some form of intelligent sampling on tokens of the output of the LLM 130a or 130b to correct the output without causing the prompt generation module 112 to prompt the LLM 130a or 130b to regenerate its output.

As noted above, the automatic correction system 102 may include and/or have access to one or more large language model (LLM) or other language model, and the LLM may be fine-tuned or trained on appropriate training data (e.g., annotated data showing correct or incorrect pairings of sample natural language queries and responses). After receiving a user input, the automatic correction system 102 may generate and provide a prompt to a LLM 130a, which may include one or more large language models trained to fulfill a modeling objective, such as task completion, text generation, summarization, etc.

The LLM 130a and various modules of the automatic correction system 102, such as prompt generation module 112, may also communicate with one or more data processing services 120 in the course of fulfilling a user input. The data processing services 120 may include any quantity of services (or “plug-ins”) and any available type of service. For example, the data processing services 120 may include one or more search services (e.g., a table search service, an object search service, a text search service, or any other appropriate search service), indexing services, services for formatting text or visual graphics, services for generating, creating, embedding and/or managing interactive objects in a graphical user interface, services for caching data, services for writing to databases, an ontology traversing service (e.g., for traversing an ontology or performing search-arounds in the ontology to surface linked objects or other data items) or any other services. For example, the LLM 130a may request (either directly or through automatic correction system 102) for data processing services 120 to perform a specific process. In some implementations, the data processing services 120 may be a part of the automatic correction system 102 (e.g., as part of a data processing services module of the automatic correction system 102).

The automatic correction system 102 may then receive an output from an LLM 130a and provide a result to a user. In some embodiments, the automatic correction system 102 may provide the entire output from the LLM 130a as a result to the user, while in other embodiments, the automatic correction system 102 may modify or automatically correct the output before providing a result to a user. The result that is provided to a user (in response to a user input) may include text, images, maps, interactive graphical user interfaces, datasets, database items, audio, actions, or other types or formats of information. In some embodiments, an action included in the results may only be executed subject to a further confirmation from a user, thus providing important oversight of the automatic correction system 102. Actions may include writing to datasets (e.g., adding or updating rows of a table, editing or updating an object type, updating parameter values for an object instance, generating a new object instance), implementing integrated applications (e.g., an email or SMS application), communicating with external application programming interfaces (APIs), and/or any other functions that communicate with other external or internal components. For example, results provided to a user (e.g., via the user interface module 104) may include a message indicating that the request is unsupported, or a message indicating that more information or clarification is needed to process the request.

As shown, the automatic correction system 102 may be capable of interfacing with multiple LLMs. This allows for experimentation and adaptation to different models based on specific use cases or requirements, providing versatility and scalability to the system. In some implementations, the automatic correction system 102 may interface with a second LLM 130b in order to, for example, generate an input to a data processing service 120, or to generate some or all of a natural language prompt (e.g., generate a prompt for the first LLM 130a).

### Example System and Related Modules

FIG. 1B depicts example connections between various modules of the automatic correction system 102 of FIG. 1A, including the user interface module 104, the prompt generation module 112, the test generation module 110, the automatic validation module 106, and the output correction module 108. In other embodiments, the automatic correction system 102 may include fewer or additional connections. The indicated connections and/or data flows of FIG. 1B are exemplary of only certain processes performed by the automatic correction system 102 and is not meant to include all possible blocks and participants.

As described above, the user interface module 104 is configured to generate user interface data that may be rendered on the user device 150 (which generally refers to a computing device of any type and/or a human user of the device), such as to receive an initial user input, as well as later user input that may be used to initiate further data processing. In some embodiments, the functionality discussed with reference to the user interface module 104, and/or any other user interface functionality discussed herein, may be performed by a device or service outside of the automatic correction system 102 and/or the user interface module 104 may be outside the automatic correction system 102. A user 150 may provide a user input to the user interface module 104 indicating a natural language request for some data analysis to be performed.

The user input along with other supplemental information or instructions, if any, may be transmitted to the prompt generation module 112 to generate a prompt that will be transmitted to the LLM 130. In some embodiments, the user may select one or more tools that may be used by the LLM and/or one or more object types to limit processing by the automatic correction system 102 to only those selected object types (which may increase speed and relevance of responses provided by the system), while in other embodiments the user may not provide any information except an initial input. After receiving the user input and/or other supplemental information or instructions from the user interface module 104 and/or other modules of the automatic correction system 102, the prompt generation module 112 may generate a prompt and transmit the prompt to the LLM 130.

Based on various inputs received from the user interface module 104 and/or prompt generation module 112 (e.g., user input and/or the prompt to the LLM 130), the test generation module 110 may generate one or more tests (also referred to as “validation tests”) that will be utilized by the automatic validation module 106 to validate one or more output from the LLM 130. For example, based on the user input or the prompt to the LLM, the system may infer the user's desired output type and incorporate the inferred desired output type as at least a portion of the tests. Desired output type(s) can include, but not limited to, a string, text, binary, floating point, character, Boolean, timestamp, date, and/or the like.

Using validation tests received from the test generation module 110 and output received from the LLM 130, the automatic validation module 106 may validate the output of the LLM 130. For example, the automatic validation module 106 may determine if the output of the LLM 130 matches expectation of a user based on the one or more validation tests generated by the test generation module 110. When the output of a LLM passes a test, the automatic validation module 106 may then transmit and cause the output of the LLM to be presented to the user 150 through the user interface module 104. On the other hand, when the output of the LLM fails the test, the automatic validation module 106 may prevent the output of the LLM from being presented to the user 150 through the user interface module 104 and may transmit a trigger signal to trigger the output correction module 108 to automatically correct the output of the LLM, which may include causing the prompt generation module 112 to generate a new prompt for the LLM to generate an updated output.

Responsive to receiving the trigger signal from the automatic validation module 106, the output correction module 108 may facilitate automatic correction on the output of the LLM 130. In some embodiments, the output correction module 108 may transmit specific information to prompt generation module 112 and cause the prompt generation module 112 to generate prompt(s) that includes the specific information to more accurately identify aspects of current output that need correction. Additionally and/or alternatively, the output correction module 108 may correct output of the LLM 130 using techniques that do not cause the prompt generation module 112 to generate new prompts for feeding into the LLM. For example, the output correction module 108 may perform some form of intelligent sampling on tokens of the output of the LLM 130a or 130b to correct the output without causing the prompt generation module 112 to prompt the LLM 130a or 130b to regenerate its output, and transmit the corrected output to the user interface module 104 for presenting to user 150.

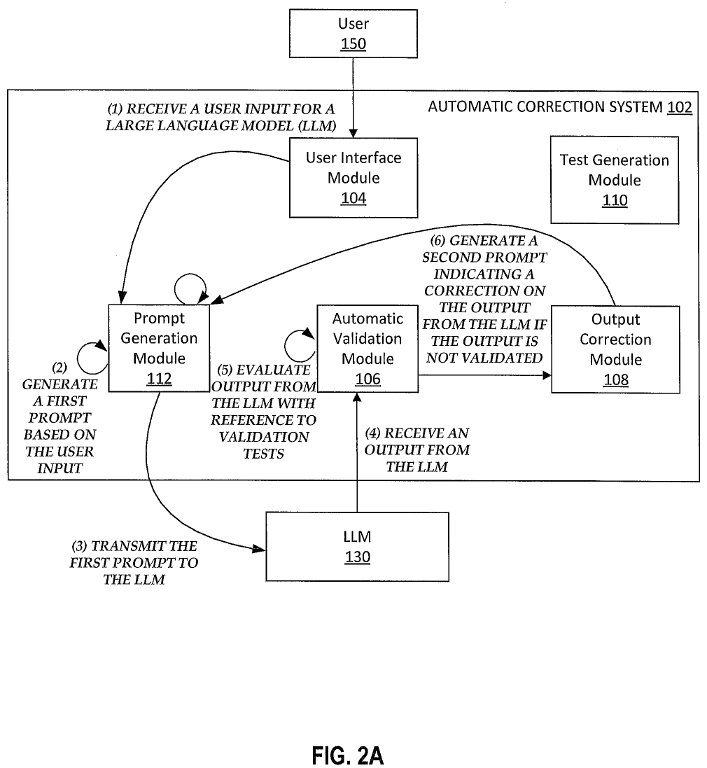

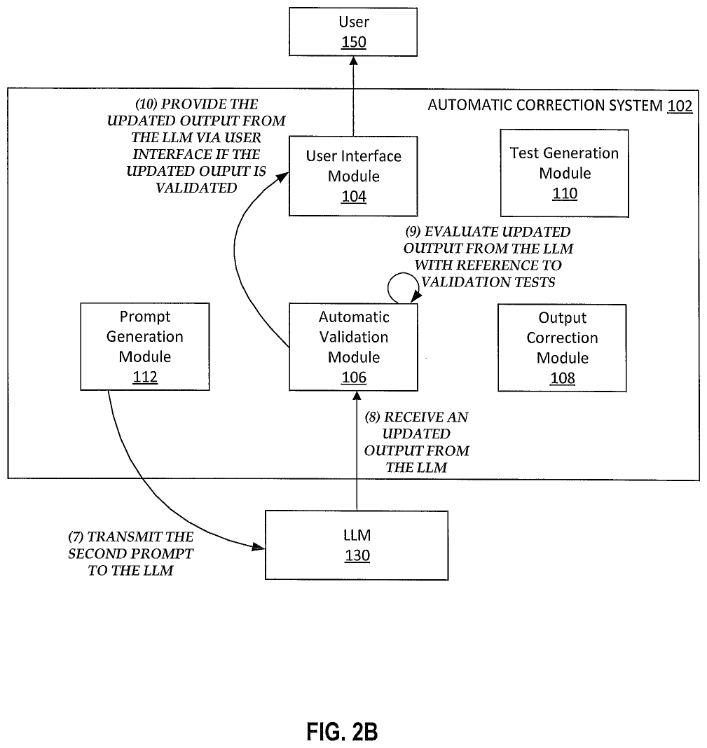

With reference to FIGS. 2A-B, illustrative interactions will be described depicting how elements of the automatic correction system 102 of FIGS. 1A-1B (e.g., the automatic validation module 106, the test generation module 110, and the output correction module 108) can provide for validating, regenerating and correcting outputs of the LLM 130. Specifically, FIGS. 2A-2B depict illustrative interactions among various modules of the automatic correction system 102 of FIGS. 1A-1B to automatically validate output from the LLM 130 and/or prompt the LLM 130 to regenerate output to avoid LLM hallucinations.

The interactions of FIG. 2A begin at (1), where the user interface module 104 receives a user input for a LLM (e.g., LLM 130) from the user 150. The user 150 may provide a user input to the user interface module 104 indicating a natural language request for some data analysis to be performed. The user interface module 104 may then transmit the user input to the prompt generation module 112. As noted above, besides the user input, the prompt generation module 112 may receive other supplemental information or instructions for generating prompt to the LLM 130. For example, the user 150 may select through the user interface module 104 one or more tools that are accessible to the LLM 130.

Next, at (2), prompt generation module 112 may generate a first prompt to the LLM 130 based at least on the user input received by the user interface module 104 at (1). The prompt generation module 112 may generate the first prompt based on the user input received from the user interface module 104 and/or other supplemental information or instructions.

Then, at (3), the prompt generation module 112 may transmit the first prompt to the LLM 130. The LLM 130 may generate an output based on the first prompt. As noted above, the automatic correction system 102 can incorporate and/or communicate with the LLM 130 to perform various functions. Such communications may include, for example, a context associated with an aspect or analysis being performed by the automatic correction system 102, a user-generated prompt, an engineered prompt, prompt and response examples, example or actual data, and/or the like. Specifically, the automatic correction system 102 may employ the LLM 130, via providing the first prompt to, and receiving an output from, the LLM 130. The automatic correction system 102 may employ the LLM 130 to, for example, determine a modeling objective (e.g., based on one or more models and/or other information), identify additional models that may be related to the modeling objective, determine or generate a model location, determine or generate a model adapter configuration, determine or generate a sandbox or container implementation, and/or the like.

Thereafter, at (4), the automatic validation module 106 may receive the output from the LLM 130. The output of the LLM 130 may vary based on the first prompt provided by the prompt generation module 112. Example output type(s) can include, but not limited to, a string, text, binary, floating point, character, Boolean, timestamp, date, and/or the like.

At (5), the automatic validation module 106 evaluates the output from the LLM 130 with reference to validation tests generated by the test generation module 110. The validation tests may be generated based on various inputs, such as may be received by the user interface module 104 at (1). For example, based on the user input, the test generation module 110 may infer the user's desired output type and incorporate the inferred desired output type as at least a portion of the validation tests. Desired output type(s) can include, but not limited to, a string, text, binary, floating point, character, Boolean, timestamp, date, and/or the like. Optionally and/or alternatively, the user interface module 104 may solicit from the user a desired schema for output of the LLM 130 and, if the user provides the desired schema, the test generation module 110 may include the desired schema for output of the LLM 130 into the validation tests. In other examples, the test generation module 110 may generate the validation tests based on one or more tools provided to the LLM 130 by the automatic correction system 102, the user 150, and/or a third-party. For example, the test generation module 110 may use a tool to generate the validation tests. The tool may be provided to the LLM 130 by the user 150 to be utilized by the LLM 130 for data processing. The tool may be a software (e.g., plugins) that may be executed by the automatic correction system 102 or be configured to communicate with the LLM 130 as well as proprietary and/or publicly available data sources for consummating certain services, tasks or processing. Based on the validation tests generated by the test generation module 110, the automatic validation module 106 may evaluate the output from the LLM 130 with reference to validation tests.

If the output of the LLM 130 is not validated with reference to validation tests at (5), the automatic validation module 106 may not cause the output of the LLM 130 to be presented to the user 150 through the user interface module 104. Instead, as illustrated at (6), the automatic validation module 106 may cause the output correction module 108 and the prompt generation module 112 to generate a second prompt indicating a correction on the output of the LLM 130. The second prompt may be a natural language prompt that is generated by the prompt generation module 112 based on data provided by the user interface module 104 and/or other modules associated with the automatic correction system 102. For example, the second prompt may be the natural language prompt that is generated based on how the user 150 manipulates the user interface module 104 (e.g., dropdowns on a graphical user interface). Additionally, rather than generating a prompt that is generic or corresponding to a high-level description of aspects where output of the LLM needs correction, the output correction module 108 may cause the prompt generation module 112 to generate the second prompt that includes detailed instructions or information to the LLM 130 without requiring interventions from the user 150 or developers. The prompt generation module 112 may generate the second prompt including detailed instructions or information for the LLM 130 to regenerate output based on various data and/or instructions provided to the automatic correction system 102 and/or the LLM 130. The various data and/or instructions may include, but not limited to, profile data associated with the user 150, context data associated with the user 150 or a user session, ontology data, and the like. Advantageously, the second prompt generated by the prompt generation module 112 based on information and/or data provided by the output correction module 108 may allow the LLM 130 to pinpoint the issues associated with its output, thereby enabling the LLM 130 to more efficiently improve its output by reducing the number of iterations needed for output correction.

Although not illustrated in FIG. 2A, the output correction module 108 may correct output of the LLM 130 using techniques that do not require causing the prompt generation module 112 to generate the second prompt to the LLM 130. For example, the output correction module 108 may perform some form of intelligent sampling on tokens of the output of the LLM 130 to correct the output without causing the prompt generation module 112 to prompt the LLM 130 to regenerate its output.

With reference now to FIG. 2B, at (7), the prompt generation module 112 may transmit the second prompt to the LLM 130 so that the LLM 130 may generate an updated output (or a “corrected output’) responsive to the second prompt. In some examples, the second prompt may include some or all of the conversation history along with notification that the object type identified in the previous output of the LLM 130 is invalid, and provide the LLM 130 with an object type that is valid. In other examples, the second prompt may notify the LLM 130 that a tool that is identified in the output of the LLM 130 is not available, and provide the LLM 130 with one or more tools that are available and/or appropriate such that the LLM 130 may regenerate and more likely improve its output with available tools. In still other examples, the second prompt may notify the LLM 130 that an item the LLM 130 is attempting to access does not exist, and provide the LLM 130 with items that exist.

Then, at (8), the automatic validation module 106 receives the updated output from the LLM 130. As noted above, the updated output from the LLM 130 may be generated based on the second prompt that includes details describing one or more aspects of the output of the LLM 130 that need corrections.

At (9), the automatic validation module 106 evaluates the updated output from the LLM 130 with reference to validation tests generated by the test generation module 110. The automatic validation module 106 may adjust how validation tests are utilized to validate the updated output of the LLM 130. In some examples, the automatic validation module 106 may dictate that the updated output of the LLM 130 is validated when the updated output exactly matches with the rules contained within the validation tests. For example, the automatic validation module 106 may apply a syntax-based rule on the updated output of the LLM 130 and only validates the updated output of the LLM 130 when the updated output of the LLM 130 literally matches what is specified in the syntax-based rule. In other examples, the automatic validation module 106 may evaluate the updated output from the LLM 130 using the validation tests without requiring exact matching between the output of the LLM 130 and the validation tests. For example, the automatic validation module 106 may run the validation tests by checking for fuzzy matches (e.g., the output of the LLM 130 does not include or mention some subject matters) between the output of the LLM 130 and the validation tests. As such, the automatic validation module 106 may dynamically adjust the rigorousness of validation through, for example, affecting how many iterations may be needed before the updated output of the LLM 130 can pass the validation tests.

If the updated output from the LLM 130 is validated with reference to validation tests, then at (10), the automatic validation module 106 may provide the updated output of the LLM 130 to the user interface module 104. Advantageously, LLM hallucinations or errors may be resolved by the automatic correction system 102 through the automatic validation, regeneration, and/or correction on the output of LLMs described in (1)-(9) above, without requiring further input from the user 150. Additionally, erroneous or inferior output of the LLM 130 may be withheld from being presented to the user 150.

### Example Flow Charts

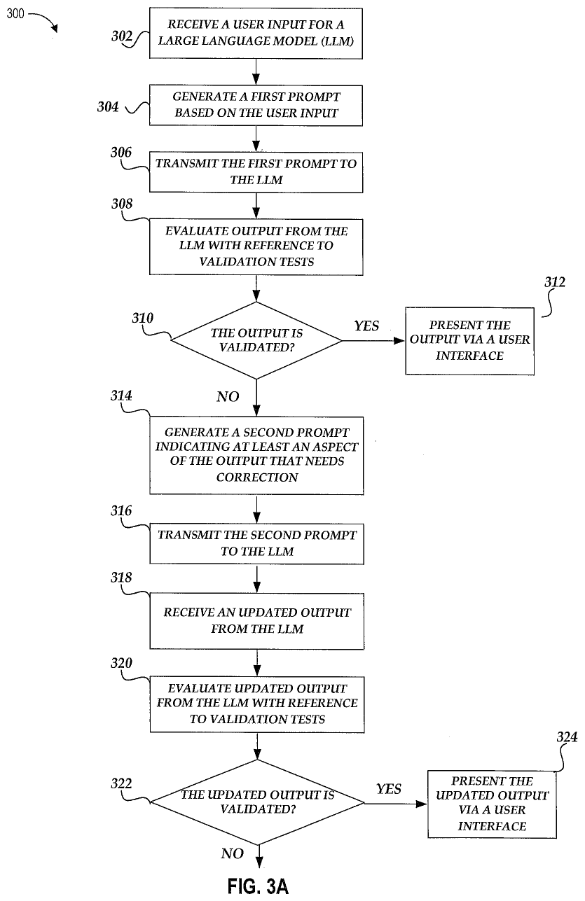

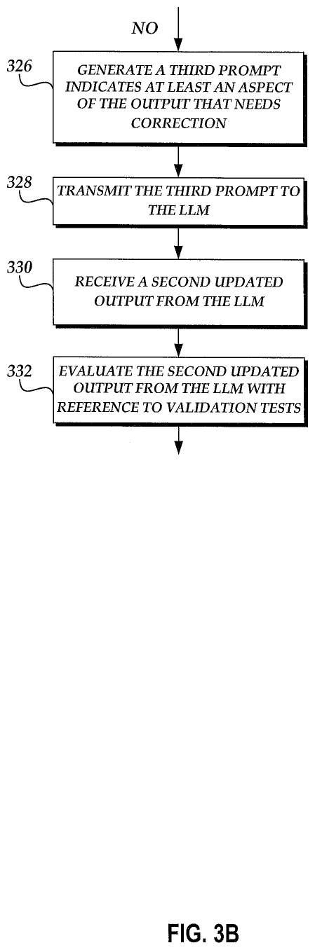

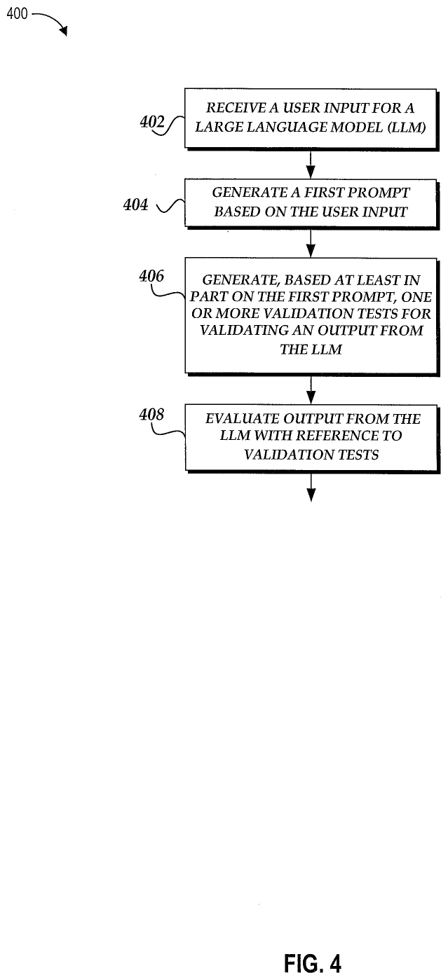

FIGS. 3A, 3B, and 4 show flowcharts illustrating example operations of the automatic correction system 102 (and/or various other aspects of the example computing environment 100), according to various embodiments. The blocks of the flowcharts illustrate example implementations, and in various other implementations various blocks may be rearranged, optional, and/or omitted, and/or additional block may be added. In various embodiments, the example operations of the system illustrated in FIGS. 3A, 3B and 4 may be implemented, for example, by the one or more aspects of the automatic correction system 102, various other aspects of the example computing environment 100, and/or the like.

FIGS. 3A-3B depict flowcharts illustrating an example method 300 according to various embodiments. At block 302, the automatic correction system 102 receives a user input for a LLM. For example, the user interface module 104 may receive the user input for the LLM 130 from the user 150. The user 150 may provide the user input to the user interface module 104 indicating a natural language request for some data analysis to be performed by the LLM 130 and/or the automatic correction system 102. The user 150 may further select through the user interface module 104 one or more tool and/or object types to limit processing by the automatic correction system 102 and/or the LLM 130.

At block 304, the automatic correction system 102 generates a first prompt based on the user input. For example, based at least on the user input received by the user interface module 104 at block 302, the prompt generation module 112 may generate the first prompt for the LLM 130.

At block 306, the automatic correction system 102 transmits the first prompt to the LLM. For example, the prompt generation module 112 may transmit the first prompt to the LLM 130. Based on the first prompt, the LLM 130 may generate output. As noted above, the LLM 130 may be utilized by the automatic correction system 102 for performing various operations, such as fulfilling a modeling objective provided in the first prompt.

At block 308, the automatic correction system 102 receives output from the LLM. For example, the automatic validation module 106 may receive output from the LLM 130, where the output from the LLM 130 may be associated with the operations discussed above.

At block 310, the automatic correction system 102 evaluates the output from the LLM with reference to validation tests. For example, the automatic validation module 106 may evaluate the output from the LLM 130 with reference to validation tests generated by the test generation module 110.

The method 300 then varies according to whether output from the LLM is validated, as determined at block 312. In the instance that output from the LLM is validated, block 312 evaluates as “YES” and the method 300 proceeds to block 314, where the automatic correction system 102 presents the output of the LLM via a user interface. For example, the user interface module 104 may present the output of the LLM 130 to a graphical user interface (GUI) and/or cause the output of the LLM 130 be presented through a user interface of the user 150.

In the instance that the output from the LLM is not validated, then block 312 evaluates as “NO” and the method 300 proceeds to block 316, where the automatic correction system 102 generates a second prompt that indicates at least an aspect of the output that needs correction. For example, the automatic validation module 106 may cause the prompt generation module 112 to generate the second prompt for the LLM 130. More specifically, the second prompt may notify the LLM 130 that the object type identified in the output of the LLM 130 is invalid, and provide the LLM 130 with an object type that is valid. Alternatively and/or additionally, the second prompt may notify the LLM 130 that a tool that is identified in the output of the LLM 130 is not available, and provide the LLM 130 with one or more tools that are available and/or appropriate such that the LLM 130 may regenerate and more likely improve its output with available tools. Alternatively and/or additionally, the second prompt may notify the LLM 130 that an item the LLM 130 is attempting to access does not exist, and provide the LLM 130 with items that exist.

At block 318, the automatic correction system 102 transmits the second prompt to the LLM. For example, the prompt generation module 112 may transmit the second prompt to the LLM 130 so that the LLM 130 may correct its output through output regeneration.

At block 320, the automatic correction system 102 receives an updated output from the LLM. For example, the automatic validation module 106 may receive the updated output from the LLM 130.

In some embodiments, the method 300 may further proceed to the flow diagram illustrated in FIG. 3B. With reference to FIG. 3B, at block 322, the automatic correction system 102 evaluates updated output from the LLM with reference to validation tests. Specifically, the automatic validation module 106 may evaluate the updated output from the LLM 130 with reference to validation tests generated by the test generation module 110.

The method 300 then varies according to whether the updated output from the LLM is validated, as determined at block 324. In the instance that the updated output from the LLM is validated, block 324 evaluates as “YES” and the method 300 proceeds to block 326, where the automatic correction system 102 presents the updated output of the LLM via a user interface. For example, the user interface module 104 may present the updated output of the LLM 130 to a graphical user interface (GUI) and/or cause the updated output of the LLM 130 be presented through a user interface of the user 150.

In the instance that the updated output from the LLM is not validated, then block 324 evaluates as “NO” and the method 300 proceeds to block 328, where the automatic correction system 102 generates a third prompt that indicates at least an aspect of the updated output that needs correction. For example, the automatic validation module 106 may cause the prompt generation module 112 to generate the third prompt for the LLM 130, where the third prompt indicates to the LLM 130 at least an aspect of the updated output that needs correction.

At block 330, the automatic correction system 102 transmits the third prompt to the LLM. For example, the prompt generation module 112 may transmit the third prompt to the LLM 130 so that the LLM 130 may correct its updated output through output regeneration.

At block 332, the automatic correction system 102 receives a second updated output from the LLM. For example, the automatic validation module 106 may receive the second updated output from the LLM 130.

FIG. 4 is a flowchart illustrating an example method 400 according to various embodiments. In some implementations, the method 400 may be performed in part or in full by the automatic correction system 102, including various modules within the automatic correction system 102.

At block 402, the automatic correction system 102 receives a user input for a LLM. For example, the user interface module 104 may receive the user input from the user 150 for the LLM 130 to perform one or more operations.

At block 404, the automatic correction system 102 generates a first prompt based on the user input. Specifically, the first prompt may be a natural language prompt that is generated based on data received by the user interface module 104 and/or other modules associated with the automatic correction system 102. For example, the first prompt may be the natural language prompt that is generated based on a user's manipulation of the user interface (e.g., dropdowns on a graphical user interface of the user 150). Additionally and optionally, the first prompt may be generated based on other supplemental information or instructions, if any, provided to the prompt generation module 112.

At block 406, the automatic correction system 102 generates one or more validation tests for validating an output from the LLM based at least in part on the first prompt. Specifically, the test generation module 110 may generate one or more validation tests for validating an output from the LLM 130 based at least in part on the first prompt. In some examples, test generation module 110 may generate the validation tests based on one or more tools provided to the LLM 130 by the automatic correction system 102, the user 150, and/or a third-party. In other examples, the test generation module 110 may generate one or more validation tests for validating output of the LLM 130 based at least on specific data that the LLM 130 is provided with. For example, if the automatic correction system 102 and/or the LLM 130 is provided with some ontology data, the test generation module 110 may generate the one or more validation tests such that the one or more validation tests refer to the ontology data. Advantageously, output from the LLM 130 that passes the one or more validation tests may be coherent or consistent with the ontology data.

At block 408, the automatic correction system 102 evaluates output from the LLM with reference to the one or more validation tests. More specifically, the automatic validation module 106 may evaluate output from the LLM 130 with reference to the one or more validation tests generated by the test generation module 110. In some embodiments, the one or more validation tests include validations tests configured to validate format of information in the output from the LLM 130, type of information in the output from the LLM 130, and/or business rules associated with the information in the output from the LLM 130. In some embodiments, the business rules may define or constrain some aspects of a business, describe operations and constraints that apply to an entity, and/or specify one or more actions to be taken when certain conditions are met. For example, a business rule may state that there is no need to perform credit check on return customers. As another example, a business rule may state that an item is not to be delivered until a down payment is received. As still another example, the business rule may require agents of an entity to use a list of preferred suppliers compiled by the entity. Additionally and optionally, the automatic correction system 102 may customize business rules based on user input or from the user 150 or preferences of an organization or an entity, and incorporate customized business rules into the one or more validation tests to validate output from the LLM 130. As such, output from the LLM 130 that is validated may make sense from business perspective or may be tailored to specific business rules preferred by the user 150, the organization or the entity. In various embodiments, the one or more validation tests may comprise at least one of a syntax-based rules (e.g., grammatical checks on output of LLM 130), semantic rules (e.g., for preventing certain ideas or concepts be grouped together to make output of LLM 130 coherent to contexts), formality-based rules (e.g., checking whether a format of output of LLM 130 is correct), character-based rules (e.g., checking the correctness and reasonableness of character(s) present in output of LLM 130), object-based rules (e.g., checking whether object type(s) present in output of LLM 130 exist or not), tool-based rules (e.g., checking whether tool(s) utilized to generate output of LLM 130 is intended based on user input or used correctly by the LLM 130 or includes the function that the LLM 130 tries to leverage), domain knowledge based rules (e.g., specifying certain business actions should not be executed in certain orders) or the like, and any combinations thereof.

Additionally, the one or more validation tests may specify positive limitation (e.g., specifying certain object types, tools or texts should appear in the output of LLM 130) or negative limitation (e.g., specifying certain object types, tools or texts should not appear in the output of LLM 130) on the output of LLM 130. It should be noted that the rules used by the test generation module 110 to generate tests may vary depending on identity of the user. For example, the test generation module 110 may incorporate different rules to the validation tests for different users. As such, validation tests for validating output of the LLM 130 may be based on “profile” or identity associated with a particular user, role, cohort, use case, organization, and/or context.

In still other embodiments, the one or more validation tests comprise a model, where output and/or updated output from the LLM 130 are transmitted to the model for evaluation based on the one or more validation tests. In some examples, the model is one of a language model, a AI model, a generative model, a machine learning (“ML”) model or a neural network (“NN”). For example, the model may be a second LLM trained to check the output of the LLM 130 such that whether the output of the LLM 130 passes validation depends on the checking result from the second LLM. The second LLM may be a LLM that is specifically trained to spot errors of certain kinds (e.g., syntax or semantic errors). Alternatively, the second LLM may be designed to evaluate or analyze whether tones manifested in the output of the LLM 130 is appropriate in certain context (e.g., doing business transaction with clients).

### Example User Interface

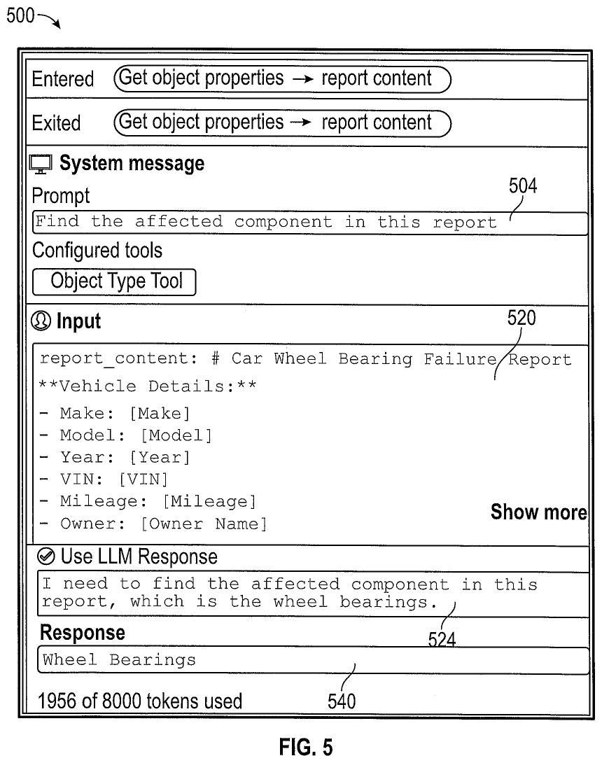

FIGS. 5-8 show an example user interface 500 that illustrates automatic validation, correction and regeneration of output of LLM(s) that may be performed by the automatic correction system 102 of FIGS. 1A, 1B, 2A and 2B. The example user interface 500 may be presented through the user interface module 104 of the automatic correction system 102 or a user interface of the user 150.

As shown in FIG. 5, the user interface 500 can include a message portion 504 that shows a prompt that is sent to a LLM (e.g., LLM 130). Here, the message portion 504 states, “Find the affected component in this report.” Although not illustrated in FIG. 5, additional remarks may be included in the message portion 504. For example, the message portion 504 may be used to generate a longer prompt comprising multiple paragraphs of specific instructions, examples of acceptable output of the LLM 130, logical explanations, instructions for formatting the output of the LLM 130, and/or other aspects described herein. The instructions for formatting the output of the LLM 130 can include, for example, a custom computer language in which the output or part of the output of the LLM 130 should be written. The instructions can include examples of desired or required formatting (e.g., grammatical structure, syntax, terminology, etc.). The message portion 504 may be generated by the prompt generation module 112 based at least in part on user input from the user 150. Alternatively and/or optionally, the automatic correction system 102 may allow the user 150 to set or configure the message portion 504. In some embodiments, the prompt generation module 112 may generate the message portion 504 and transmit the message portion 504 to the LLM 130.

The user interface 500 can include input 520, which may be provided by the user and/or automatically by the system. The input 520 shows what will be transmitted to the LLM (e.g., LLM 130) as part of a prompt. The input 520 may be generated or reproduced based on instructions provided, for example, by the message portion 504. In some implementations, the input 520 corresponds to (e.g., is set to be the same as) the message portion 504.

The LLM response portion 524 may identify the LLM's response to the prompt (e.g., that includes some or all of the input 520 and the message portion 504). In this example, in the LLM response portion 524, the LLM has indicated a main or overall goal. For example, the LLM response portion 524 may be output from the LLM 130 as a response from specific instructions included in a system query (e.g., from the message portion 504). As shown in FIG. 5, the LLM response portion 524 in this example recites, “I need to find the affected component in this report, which is the wheel bearings.” Although not illustrated in FIG. 5, the LLM response portion 524 may further include other information showing the “intent” or “thought” of the LLM 130. For example, the LLM response portion 524 may include a tool object type associated with a tool that the LLM 130 intends to use. As another example, the LLM response portion 524 may include a component identification number associated with the report that the LLM intends to find. In some embodiments, the LLM 130 may transmit the LLM response portion 524 to the automatic validation module 106.

The user interface 500 can include portion 540. The portion 540 may show output from a LLM. Specifically, the portion 540 may be output from the LLM 130. Here, the portion 540 shows “Wheel Bearings.” In some embodiments, the automatic validation module 106 may receive the portion 540 from the LLM 130 and validate the portion 540 using one or more validation tests generated by the test generation module 110. Here, the one or more validation tests may include a component identification number that should be included in the output of the LLM 130, where the one or more validation tests may be generated based on user input from the user 150 and/or the message portion 504 (e.g., the report). As such, the portion 540 may not pass the validation tests and the automatic validation module 106 may trigger the output correction module 108 to correct the portion 540.

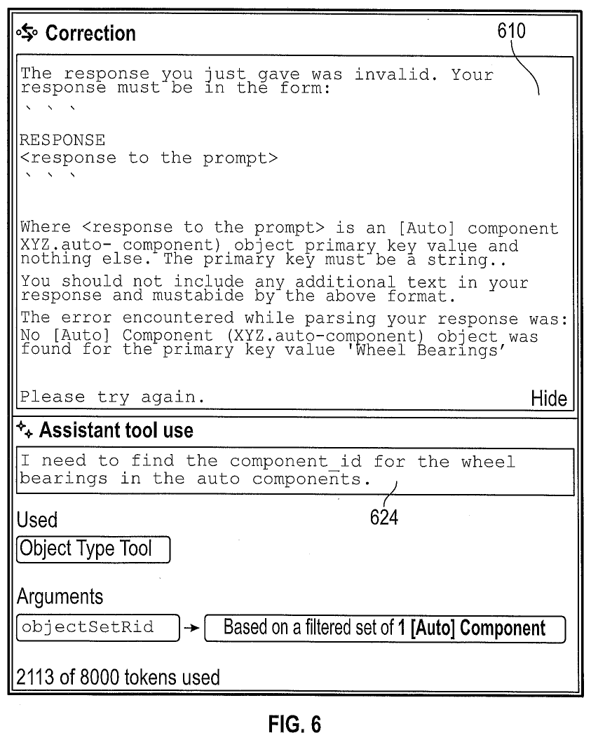

With reference to FIG. 6, an updated prompt 610 that may be provided by the prompt generation module 112 to the LLM 130 for the LLM 130 to correct its output. Rather than providing the LLM 130 with prompts that are generic in nature, the output correction module 108 may cause the prompt generation module 112 to generate the updated prompt 610 that includes specific information to more accurately identify aspects of current output that need correction. For example, the updated prompt 610 indicates formality issues (e.g., “Your response must be in the form:” and “You should not include any additional text in your response and must abide by the above format.”) associated with the LLM response in portion 540. Additionally, the updated prompt 610 notifies the LLM 130 some errors (e.g., “No [Auto] Component (XYZ.auto-component) object was found for the primary key value ‘Wheel Bearings’”) associated with the portion 540. Further, the updated prompt 610 prompts the LLM 130 to regenerate its output (e.g., “Please try again.”) based on the information mentioned in the updated prompt 610.

The LLM response portion 624 may identify the LLM's identification of the main or overall goal based on the updated prompt 610. For example, the LLM response portion 624 may be output from the LLM 130 as a response from specific instructions and information included in the updated prompt 610. As shown in FIG. 6, the LLM response portion 624 in this example recites, “I need to find the component_id for the wheel bearings in the auto components.” As depicted in FIG. 6, the information provided by the updated prompt 610 (“No [Auto] Component (XYZ.auto-component) object was found for the primary key value ‘Wheel Bearings’”) enables the LLM 130 to regenerate updated output that may better match expectation from the user 150.

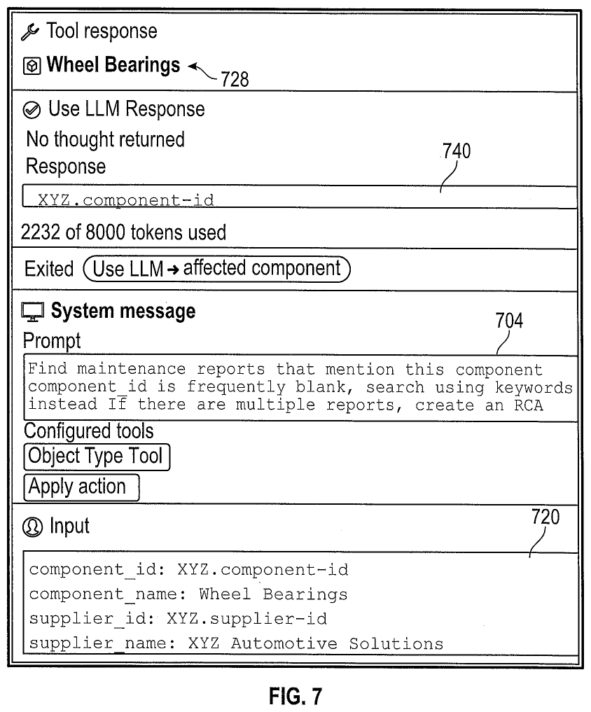

With reference to FIG. 7, the portion 728 may include a substantive response from the LLM 130 regarding which tool to use, how to use the tool, and/or what to include as input for a particular tool. As shown in FIG. 7, the portion 728 shows “Wheel Bearings,” which corresponds to an input that is to be used in a particular tool.

The updated output 740 shows the updated output from the LLM 130. Here, the updated output 740 shows a string (e.g., XYZ.component-id) that provides a component identification number of a component (e.g., wheel bearings). The updated output 740 indicates that the updated output from the LLM 130 is consistent with prompt (e.g., the updated prompt 610) generated by the prompt generation module 112. For example, the updated output 740 includes only the string (e.g., XYZ.component-id) and does not include “any additional text” as instructed to the LLM 130 in the updated prompt 610.

In some embodiments, the automatic validation module 106 may validate the updated output 740 using the one or more validation tests described above. In contrast to the portion 540, the updated output 740 includes the component identification number that should be included and would pass the validation tests with respect to correctly identifying the component identification number. Yet, the updated output 740 may still not meet expectation of the user 150 because the updated output 740 does not include reports that mention the component (e.g., wheel bearing).

Based on the user input from user 150 and/or the message portion 504, the output correction module 108 may cause the prompt generation module 112 to generate the portion 704 as another prompt to the LLM 130. Here, the portion 704 provides specific instructions to the LLM 130 (e.g., “Find the maintenance reports that mention this component” “component_id is frequently blank, search using keywords instead” “If there are multiple reports, create an RCA”).

The input 720 then allows the user 150 to identify what the LLM 130 identifies as its input (e.g., the prompt to the LLM 130). The input 720 may be generated or reproduced based on instructions provided, for example, by the portion 704. In some implementations, the input 720 may correspond to (e.g., is set to be the same as) the portion 704. Here, the input 720 suggests the LLM 130 identifies the “component_id: XYZ. component_id” and other information as its input for generating a second updated output.

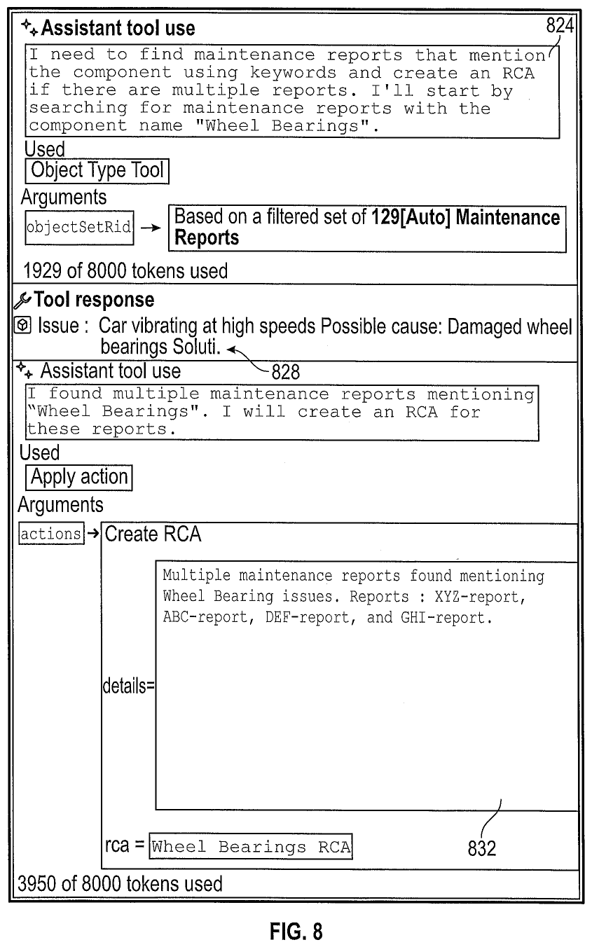

With reference to FIG. 8, the portion 824 may identify the LLM's identification of the main or overall goal based on the portion 704. For example, the portion 824 may be output from the LLM 130 as a response from specific instructions included in a system query (e.g., from the portion 704). As shown in FIG. 8, the portion 824 in this example recites, “I need to find maintenance reports that mention the component using keywords and create an RCA if there are multiple reports. I'll start by searching for maintenance reports with the component name “Wheel Bearings”.” As indicated by the portion 824, the LLM 130 “intends” to do what is provided in the portion 704.

As shown in FIG. 8, the portion 828 may include a substantive response from the LLM 130 regarding what the LLM 130 finds based on the main or overall goal identified in portion 824. The portion 828 reads “I found multiple maintenance reports mention “Wheel Bearings”. I will create an RCA for these reports.” Based on the “intention” of the LLM stated in the portion 828, the portion 832 further shows the multiple maintenance reports mentioning wheel bearings issues found by the LLM 130. In various embodiments, the LLM 130 may transmit the portion 828 and the portion 832 to the automatic validation module 106 and/or other components of the automatic correction system 102.

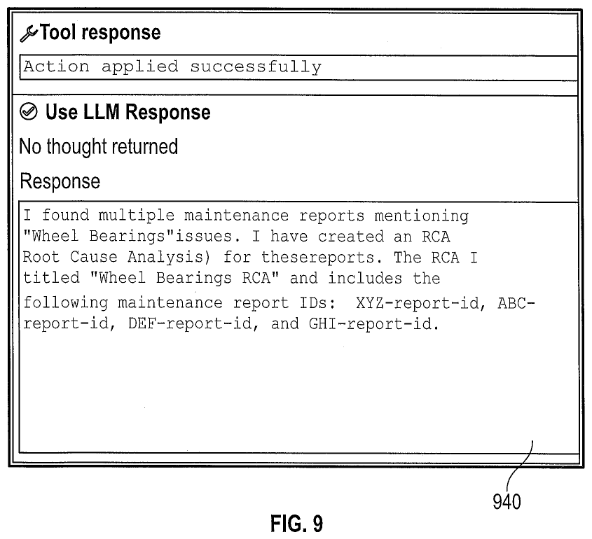

With reference to FIG. 9, the updated output 940 shows the second updated output generated by the LLM 130 received by the automatic correction system 102. Here, the updated output 940 provides “I found multiple maintenance reports mentioning “Wheel Bearings” issues. I have created an RCA (Root Cause Analysis) for these reports . . . ” The automatic validation module 106 may validate the updated output 940 based on the one or more validation tests discussed above.

As the updated output 940 meets the expectation of the user 150, the automatic validation module 106 may determine that the updated output 940 passes the one or more validation tests. Responsive to such determination, the automatic validation module 106 may transmit the updated output 940 to the user interface module 104 for presenting the updated output 940 to the user 150.

### Overview Of Saving Production Runs Of A Function As Unit Test

As discussed above, the AIP systems discussed herein may be configured to generate and/or utilize validation tests (also referred to as “unit tests”) for use in testing functions that utilize LLMs (generally referred to herein as “the system”). The present disclosure further includes various processes, functionality, and interactive graphical user interfaces related to the system. According to various implementations, the system (and related processes, functionality, and interactive graphical user interfaces), can advantageously provide the ability to save data associated with execution of a function (also referred to as a “production run”), such as information included in an execution log, as a validation test. A validation test can be used to test interactions with one or more LLMs to determine if the function, and/or an update to the function, is performing as desired. The system can advantageously determine permissions for the validation test and/or the function. The system can advantageously enable users to test functions that chain LLMs together with other types of operations, such as, for example, specialized operations, machine learning models, optimization models, data lakes/sources of truth (such as an ontology of data objects), and/or the like.

### Example Aspects Related to Functions

The system may include functions that indicate interactions with an LLM. The functions may utilize interactions LLMs to perform an identified task included in the function. The identified task can be represented and/or defined by a natural language description of the task. For example, a function may utilize interactions with LLMs to perform the task of “scheduling maintenance for the oldest piece of equipment.” The task may be defined by a user, elsewhere in the system, or by other components outside of the system, such as by an LLM or other model. A function may include information that can be shared with an LLM to accomplish the task. A function may include various other function inputs such as tools, tool parameters, object types, and/or data inputs. A function may utilize the function inputs to generate prompts for LLMs based on the task and/or information received from an LLM or other model. The prompts may include natural language instructions for an interaction with an LLM that includes information that is derived from the function inputs. For example, a function may utilize function inputs to generate a prompt based on the task of “scheduling maintenance for the oldest piece of equipment” that includes information from data inputs associated with scheduling maintenance, equipment information, and/or other data needed to perform the task or identify further tasks. Upon executing a function, the system may receive responses from LLMs based on the prompt. The responses from the LLMs may contain a result for the task and/or another step or subtask for the function to use to generate another prompt for the LLMs. For example, the responses from an LLM may contain results for the task, such as information that allows the application to schedule maintenance for a piece of equipment, or a request for more information, such as a request for information from a data input that has equipment ages.

A function may be associated with one or more execution logs. As described herein, an execution log may include a record of the various function inputs, prompts, and responses received from an LLM during the execution of a function. An execution log may record a single interaction of the system and an LLM during the execution of the function or may record multiple interactions of the system and an LLM during the execution of the function. When the execution log includes multiple interactions with an LLM, the execution log may also include sub-execution logs of the individual interactions with the LLM.

In some instances, the system may generate an execution log in response to a function failure, e.g., a production run of the function may not provide the expected result. For example, the system may generate an execution log in response to a function failing one or more validation tests. In other instances, the system may generate an execution log each time a function is executed. An execution log may include a record of every function input, prompt, and response received from an LLM during the execution of a function or may include a reduced record. For example, an execution log may include a reduced record of only the function inputs, prompts and responses received from an LLM associated with a failed execution of the function.

### Example Aspects Related to Testing Functions

The system may utilize validation tests (otherwise referred to a “unit tests”) to analyze functions and responses from an LLM. A validation test may be configured to test an entire function or components of a function. A validation test can include fixed validation test inputs for some of the function inputs and validation test results. The validation test inputs may be predetermined values for some of the function inputs (e.g., the task description, data inputs, tools, etc.). The validation test results can be a predetermined outcome that is expected to occur given the validation test inputs.

To determine if a function passes a validation test, the system can compare an outcome from the execution of the function (e.g., a prompt, a response received from an LLM, a tool call, etc.) to the validation test result and determine if the outcome and the validation test result are equivalent. In some embodiments, a user compares the outcome and the validation test result and indicates if the outcome and validation test results are equivalent. In some embodiments, the outcome and the validation test results are compared using one or more models. For example, an LLM may be asked to rate how similar the outcome is to the validation test result.

In a nonlimiting example, a function may be set up to perform the task of parsing an database and scheduling appointments based on the text found in the database. Because the function utilizes nondeterministic LLMs to perform portions of the task, it is possible that the function may result in false positives. For example, the function may schedule an appointment (e.g., an online or in-person appointment for a service industry, such as medical, health and beauty, retail, etc.) that was not called for in the database. In this example, a validation test may be configured to test if variations of the natural language description of the task prevent these false positives. The validation test input may include a set of text files that do not contain text that should cause the function to schedule an appointment. The validation test result may be a predetermined outcome that no appointment is scheduled by the function. The natural language description of the task can then be varied, and the system can determine whether each variation passes the validation test. For example, the language description, “Schedule an appointment based on the attached database” may fail the validation test due to a hallucination from the LLM, while the language description, “Attached is a database. If any text file asks for an appointment, return the time and location indicated in the text file. If no text file asks for an appointment, return ‘no appointment requested’” may pass the validation test.

While the above example identifies input data as the validation test input and the natural language description of the task as variable, a validation test can have other configurations. For example, a particular natural language description of the task may be a validation test input while data inputs are variable. Any combination of the task description and function inputs may be included as validation test inputs. For example, a natural language description of the task, a data input, and a tool may all be a validation test input for a particular validation test. Further, a type of function input may include some validation test inputs and some variable inputs. For example, a set of data inputs may be included as validation test inputs while another set of data inputs may vary based on the execution of the function. Any function input that is not a validation test input may be varied so the system can determine if the variation passes the validation test.

A validation test may be utilized to test an entire function execution or portions of the function execution. For example, a validation test may be configured to test the prompt generation portion of a function. In this example, the validation test may include a prompt as the validation test result that should be generated based on the validation test input.

A validation test can include more than one interactions with an LLM. For example, the system may execute the function and generate a prompt for an LLM from the validation test inputs and variable inputs of the validation test and use the response of the LLM to generate another prompt for the LLM. This process may repeat until the system determines the response of the LLM should be compared to the validation test result. A validation test may include multiple nested validation tests. For example, a validation test may be configured to test multiple interactions between the system and an LLM. In this example, the validation test may have an overall validation test with validation test inputs and a validation test result for the overall function with sub-validation test that test individual interactions and/or portions of the individual interactions. The system can determine if each validation test in a nested validation test passes for a function execution.

### Example Aspects Related to Validation Test Generation

A validation test may be based in part on the function being tested by the validation test. For example, a previous execution of the function being tested may be converted into a validation test. A validation test may also be based in part on a different functions and/or on user definitions of portions of the validation test.

To convert a function into a validation test, a user may select one or more execution logs of the function to convert into the validation test. Once one or more execution logs are selected to convert into a unit test, the system may determine the validation test inputs and the validation test results. To determine the validation test inputs of a validation test, the system may save a portion of the function inputs in the execution log. For example, the system may save a portion of the description of the tasks and/or the tools, tool parameters, object types, and/or data inputs used in the execution log as validation test inputs. The system may receive user input selecting the validation test inputs from the execution log. For example, a user may select a portion of the description of the tasks and/or the tools, tool parameters, object types, and/or data inputs used in the execution log as the validation test inputs of a validation test.

To determine the validation test results for the validation test, the system may determine a result that should occur in the system based on validation test inputs. For example, the system may determine for a task of “scheduling maintenance for the oldest piece of equipment” that the system should schedule maintenance at a time for a specific piece of equipment. In some embodiments, the system determines the validation test results for a validation test based on one or more user inputs entering a desired result.

A function may be converted into a validation test based on a failed execution of the function. For example, a function to perform the task of “scheduling maintenance for the oldest piece of equipment” may not schedule an appointment or schedule an incorrect appointment based on the function inputs. In this example, the execution logs of the function may be converted into one or more validation tests to analyze the function and the function may be modified until the function can reliably pass the one or more validation tests. In some embodiments, a function must pass each validation test assigned to the function before the function can be utilized in a non-testing environment or may be removed from a non-testing environment in response to failing a validation test.

### Example Aspects Related to Permissions

The functions, function inputs, and/or execution logs may have sets of rules, such as permissions, constraints, qualifications, authorizations, security markings, access controls, and the like (generally referred to herein as “permissions”) that govern the access to each function, function inputs, or execution log. In order to access or execute a function, function inputs, and/or execution log, a user may need to have the permissions associated with the function, function inputs, or execution log. For example, a particular data input may contain confidential information. In this example the particular data input may be associated with a permission such that only a user with the permission can access or cause the system to access the confidential information in the data input or view the data input in the execution log.

A permission may be associated with different scopes. For instance, a permission can be applied to portions of data inputs (e.g., a data source that is accessed via a tool), such as individual data values, ranges of data values, columns of data values, rows of data values, tabs, and other portions of a data input or a combination thereof. A permission can also be applied to an entire data input or multiple data inputs. In some embodiments, a permission may be applied to one or more entire data inputs or one or more portions of data inputs. Similarly, permission can be applied to individual tools or object types or multiple functions or object types, classes of functions or object types, libraries of functions, database of object types, and the like.

The permissions applied to the functions, function inputs, and/or execution logs used in the execution of a function may be applied to one or more responses received from an LLM. In this way, all of the permissions required to access the functions and/or function inputs used to generate a prompt are also required to access the response to the prompt. The permissions applied to the functions and/or function inputs used in the execution of the function may be tracked and applied to portions of the execution log. As such, all, or a portion, of an execution log may be restricted from a user without the required permissions. For example, a user without the required permissions may be restricted or otherwise prevented from viewing portions of function inputs, prompts, and/or LLM responses in an execution log.

A user without the required permissions may be prevented from executing a function. For example, a user without the permissions to a function or function input used in execution the function may be prevented from executing the function.

When a function is converted into a validation test, any permissions associated with the function or function input may be applied to the validation test. As such, secured information used in the execution of the function remains secured in the validation test. For example, the permissions on the function or function inputs used in the execution of a function can be applied to the validation test inputs, the validation test results, and/or any intermediate data inputs, prompts, and LLM responses of a validation test.

In some embodiments, a user may request one or more permissions associated with a validation test to be removed or temporarily disabled. For example, a system developer may be using a validation test to test a modification of a function. In this example, the system developer may receive an indication that the validation test is failing but not have the required permissions to view the data inputs, the prompt, and/or the LLM responses for the validation test. As such, the system developer may have difficulty determining why the validation test is failing. In this example, the system developer may request that one or more permissions be removed or temporarily disabled so the system developer can view the restricted information. In some embodiments, when the system receives a request that a permission is to be removed or temporarily disabled, the system requests confirmation for a user with the authority over the permission (e.g., the owner of the confidential information).

### Example System

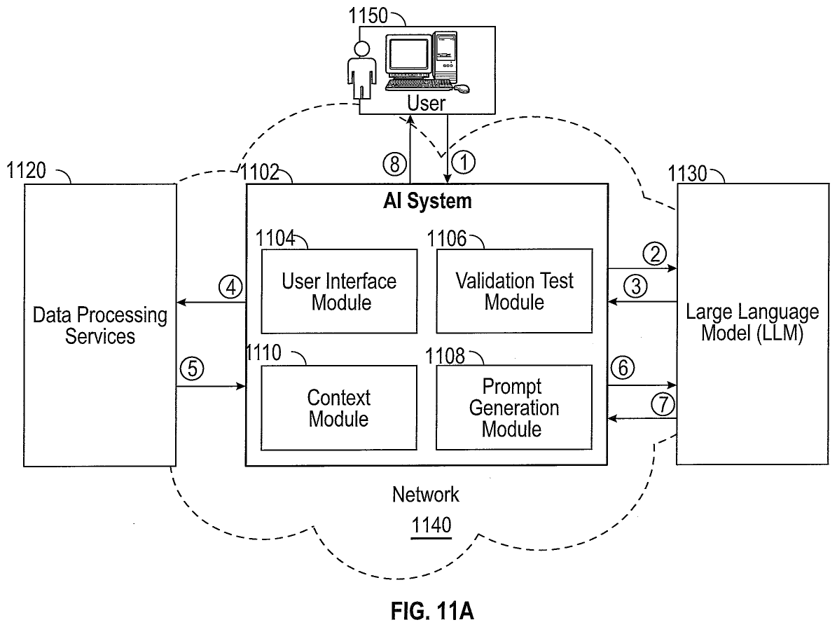

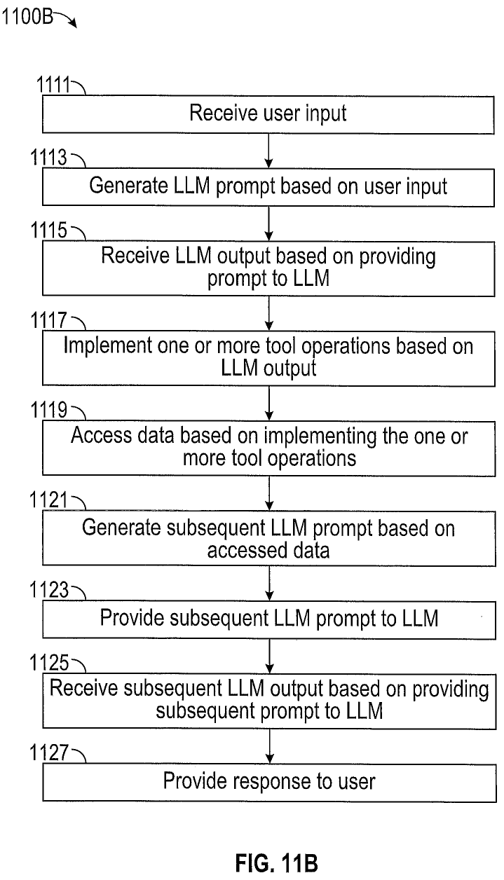

FIG. 11A is a block diagram illustrating an example Artificial Intelligence System (or “AIS”) 1102 in communication with various devices to respond to a user input and/or execute functions. In the example of FIG. 11A, the Artificial Intelligence System 1102 comprises various modules, including a User Interface Module 1104, a Validation Test Module 1106, a Prompt Generation Module 1108, and a Context Module 1110. In other embodiments, the AIS 1102 may include fewer or additional components. In some implementations, the Artificial Intelligence System 1102 may comprise the user device 1150.

In the example of FIG. 11A, the various devices are in communication via a network 1140, which may include any combination of networks, such as one or more local area network (LAN), personal area network (PAN), wide area network (WAN), the Internet, and/or any other communication network. In some embodiments, modules of the illustrated components, such as User Interface Module 1104, Prompt Generation Module 1108, and Context Module 1110 of the Artificial Intelligence System 1102, may communicate via an internal bus and/or via the network 1140.

A user interface module 1104 is configured to generate interactive user interface data that may be rendered on a user device 1150, such as to receive an initial user input, as well as later user input that may be used to initiate further data processing. In some embodiments, the functionality discussed with reference to the user interface module 1104, and/or any other user interface functionality discussed herein, may be performed by a device or service outside of the Artificial Intelligence System 1102 and/or the user interface module 1104 may be outside the Artificial Intelligence System 1102. For example, the user interface module 1104 may be comprised, in whole or in part, on the user device 1150. Example user interfaces are described in greater detail below.

A context module 1110 is configured to maintain, select, and/or provide some or all relevant context associated with a user input, user session, multiple sessions of the user, and/or other context. The context module 1110 may store context for various groups of users, e.g., user inputs from multiple users. The Artificial Intelligence System 1102, LLM, and/or other components of the system may make use of context in fulfilling their functions. Context may include, for example, all or part of a conversation history from one or more sessions with the user (e.g., a sequence of user inputs and responses or results), user selections (e.g., via a point and click interface or other graphical user interface), data processing services 1120 implemented during the session, user-selected objects and any corresponding properties for those objects, any linked objects as defined by a relevant ontology, and the like. As one example, if a most recent result returned to a user included a filtered set of “flight” objects, and a user types “send an email listing the flights to my manager,” the AIS 1102 may make use of the context of the filtered set of aircraft objects, as provided by the context module, and include a list of those objects in an email.

In some embodiments, the user interface module 1104 may suggest certain actions to the user (e.g., any actions described herein, or any other related actions) based on context provided by context module 1110 (e.g., email the account manager of the account that is being displayed).

A prompt generation module 1108 is configured to generate a prompt to a language model, such as LLM 1130. As described in further detail below, the prompt generation module 1108 may generate a prompt based on data provided by the user interface module 1104 (e.g., a user input, tool information, etc.), and/or the context module 1110 (e.g., conversation history and/or other contextual information).

In the example of FIG. 11A, a user 1150 (which generally refers to human user and/or a computing device of any type that may be operated by a human user) may provide a user input to the Artificial Intelligence System 1102 indicating a natural language request for some data analysis to be performed. In some embodiments, the user may select one or more object types to limit processing by the AIS 1102 to only those selected object types (which may increase speed and relevance of responses provided by the system), while in other embodiments the user may not provide any information except an initial input.

The Artificial Intelligence System 1102 may include and/or have access to the LLM 1130 and/or other language model, and the LLM may be fine-tuned or trained on appropriate training data (e.g., annotated data showing correct or incorrect pairings of sample natural language queries and responses). After receiving a user input, the Artificial Intelligence System 1102 may generate and provide a prompt to the LLM 1130, which may include one or more large language models trained to fulfill a modeling objective, such as task completion, text generation, summarization, etc.

In some implementations, the AIS 1102 may be capable of interfacing with multiple LLMs. This allows for experimentation and adaptation to different models based on specific use cases or requirements, providing versatility and scalability to the system. In some implementations, the AIS 1102 may interface with a second LLM in order to, for example, generate an input to a data processing service 1120, or to generate some or all of a natural language prompt (e.g., generate a prompt for the LLM 1130).

The Artificial Intelligence System 1102 may also communicate with one or more Data Processing Services 1120 in the course of fulfilling a user input and/or a task. The data processing services 1120 may include any quantity of services (or “plug-ins”) and any available type of service. For example, the services 1120 may include one or more search services (e.g., a table search service, an object search service, a text search service, or any other appropriate search service), indexing services, services for formatting text or visual graphics, services for generating, creating, embedding and/or managing interactive objects in a graphical user interface, services for caching data, services for writing to databases, an ontology traversing service (e.g., for traversing an ontology or performing search-arounds in the ontology to surface linked objects or other data items) or any other services. In some implementations, tool information provided in a prompt to the LLM enables the LLM to return a properly formatted request for further information from a plug-in, such as in the form of an API call to a data processing service. Thus, the LLM 1130 may indirectly request (via the AIS 1102) for data processing services 1120 to perform a specific process. The output from the data processing service 1120 may then be provided back to the LLM 1130 for further processing of a task and/or to develop a final result to be provided to the user. In some implementations, the data processing services 1120 may be a part of the AIS 1102 (e.g., as part of a data processing services module of AIS 1102). In some implementations, the data processing services 1120 may be external to the AIS 1102.

FIG. 11A includes a set of circles numbered from 1-8 that illustrate an example set of interactions and data that may be exchanged between various devices, such as the user 1150, AIS 1102, LLM 1130, and services 1120. In other implementations, the interactions and/or data may be ordered differently. Beginning with interaction 1, the AIS 1102 receives a user input from the user device 1150. As noted above, the user input can include a term, phrase, question, and/or statement written in a human language (e.g., English, Chinese, Spanish, etc.), a request for data, a task to be performed, information associated with a task to be performed, one or more tools (e.g., a query object tool, an apply action tool, etc.), one or more tool types (e.g., an object type, an action type, etc.), and/or other information. For example, the user input can include the task description for a function.

Next, at interaction 2 the prompt generation module 1108 generates a prompt based on at least the user input. The prompt can include the user input and/or may be generated based on other context, such as may be accessed by the context module 1110. The prompt can include information associated with one or more tools selected by the user, such as in the form of tool information, which enables the LLM 1130 to generate a tool call that can be used by the AIS to communicate with a data processing service. Tool information may indicate, for example, how data that may be accessed by the LLM (via tool calls) is structured, such as in an ontology or other format. Tool information can indicate properties associated with a particular object type, such as an object type selected by the user in the user input at interaction 1. Tool information can include instructions for implementing a tool, instructions for generating a tool call, including instructions for formatting a tool call, tool implementation examples for executing one or more tool operations, and/or other information that may allow the LLM to provide more meaningful responses to the AIS. Tool implementation examples included in an LLM prompt can include pre-defined examples (e.g., the same for each use of the tool), user-selected or user-generated examples, and/or examples that are dynamically configured by the AIS 1102 based on context.

Advantageously, supplementing a prompt with context, such as tool information may cause the LLM to generate responses to the prompt that are more useful (e.g., more relevant, accurate, and/or complete). Moreover, implementing AI system 1102 to generate prompts, which can include, context, may greatly reduce the burden of prompt design and prompt engineering on a user. Moreover, prompt generation module 1108 can generate prompts that are more effective in inducing an LLM to generate useful responses, which may greatly improve the technical field of LLM systems.

Interaction 2 shows the AIS 1102 providing a prompt, such as may be generated by prompt generation module 1108, to the LLM 1130. In response to receiving the prompt, at interaction 3 the LLM 1130 provides an output to the AIS 1102. The LLM output comprises text that may include a full or partial response to the provided task and/or information indicating additional information that may be requested by the AIS 1102. For example, the LLM output can include a tool call formatted according to instructions in tool information includes in prompt. In some implementations, the AIS 1102 can parse the LLM output to change a format of data of the LLM output. For example, the AIS 1102 may convert a text string of the LLM output to a different data format, such as a data object format that is defined by an ontology. The AIS 1102 may convert an LLM output to a data format that is compatible with data processing services 1120. Advantageously, reformatting data output from an LLM, such as from one data type to another, may improve the technical field of LLMs such as by providing a system to facilitate integrating the LLM with a data processing service which may greatly expand or enhance the capabilities of LLMs.

If the output from the LLM at interaction 3 includes a tool call, the AIS 1102 can generate a request to a data processing service 1120 at interaction 4. The request can include the tool call text directly from the LLM output and/or some or all of the tool call text reformatted to be usable by the particular data processing service. The AIS 1102 can communicate with the data processing services 1120 via one or more API calls, HTTP requests, or the like.

In response to the request, the data processing service 1120 can generate data output at interaction 5. For example, the data processing service output may be generated based on implementation of the tool call received at interaction 4. The data output may be formatted according to a structure specified by the data processing service 1120, such as according to an ontology. For example, the data output may identify a data object having one or more properties and which can be formatted according to an ontology. Data output may be in various formats, some of which may not be recognizable by the LLM 1130 (e.g., non-textual data).

In some examples, the AIS 1102 can reformat the data output from the data processing service 1120, such as to reformat a data object as a text string. The AIS 1102 may parse the data output and extract one or more properties of the data object to be formatted as a string that may be provided to the LLM 1130 to accurately “understand” and process data of the data output. Advantageously, the AIS 1102 may greatly improve the technical field of LLMs such as by providing a system to facilitate integrating the LLM with data from various sources having various data types which may greatly expand or enhance the capabilities of LLMs.

Next, at interaction 6 the prompt generation module 1108 can generate a subsequent prompt based on at least the data output from the data processing service. The subsequent prompt can include some or all of the data output (e.g., reformatted as a string), along with relevant context, such as context provided, generated, and/or accessed by context module 1110. Thus, the subsequent prompt can include some or all of the initial prompt (interaction 2) and/or the LLM output (interaction 3). In some examples, a summary of the conversation history is provided in the subsequent prompt, rather than including the full text of the conversation history.

In response to receiving the subsequent prompt, the LLM 1130 may generate a subsequent LLM output at interaction 7. The subsequent LLM output may include various information, similar to the first output received at interaction 3. For example, the subsequent LLM output may include a final response to the task, another tool call, and/or other information. In the example of FIG. 11, the subsequent prompt includes a final response, and does not include another tool call. The processes illustrated as interactions 2-6 may be repeated any number of times as the LLM makes additional tool calls to obtain further information and the data processing services outputs are provided back to the LLM.

At interaction 8 the AIS 1102 generates a final response that is to provide to the user 1150. The final response may include some or all of the subsequent LLM output and/or other information. The final response may be formatted according to a user selection, such as a string of text or data object (or link to data object stored in an ontology). A data object may be identified with a unique identifier associated with an object. The final response may include text, images, maps, interactive graphical user interfaces, datasets, database items, audio, actions, or other types or formats of information. In some implementations, the AIS 1102 may modify the LLM output to generate the final response provided to the user. For example, the AIS 1102 can parse the subsequent LLM output to change a format of data for inclusion in the final response. In some implementations, the AIS 1102 may save the final response as a variable, which may be subsequently provided to the LLM.

Advantageously, the AIS 1102 may improve the technical field of LLMs such as by improving the usefulness of LLM responses. LLM 1130 may only output data having a certain format (e.g., data formatted as a string). Formatting the data output from the LLM may allow the LLM 1130 to provide data that can be more useful to a user, such as if a user requires data in a non-string format such as for subsequent manipulation, functions, or processes.

As shown and/or described, AIS 1102 can generate a response to a user input by interacting with LLM 1130 and/or with data processing services 1120. The AIS 1102 can receive data from, and/or provide data to, the LLM 1130 and/or data processing services 1120. In some implementations, the AIS 1102 may interact with the LLM 1130 more or less than what is illustrated in FIG. 11A, such as to generate a response for a given user input (and associated task or sub-task). In some implementations, the AIS 1102 may interact with the data processing services 1120 more or less than what is illustrated in FIG. 11A, such as to generate a response for a given user input (and associated task or sub-task). In some implementations, the AIS 1102 may interact with the data processing services 1120 in response to every output from the LLM 1130 (except for a final LLM output). In some implementations, the AIS 1102 may interact with the LLM 1130 in response to every output from the data processing services 1120. The number of times the AIS 1102 interacts with the LLM 1130 and/or with the data processing services 1120 may depend on at least the initial user input.

The validation test module 1106, along with the user interface module 1104, context module 1110, and prompt generation module 1108, can generate and utilize validation tests and/or execution logs. For example, the validation test module 1106 can generate execution logs based on any of interactions 1-8 described above. As previously described, the execution logs can be utilized to generate one or more validation tests used to test functions of the AIS 1102.

FIG. 11B is a flowchart illustrating an example process 1100B for interacting with an LLM. This process, in full or parts, can be executed by one or more hardware processors, whether in association with a singular or multiple computing devices like user device 1150, AIS 1102, data processing services 1120, LLM 1130, and even devices in remote or wireless communication. The implementation may vary. For example, it could be controlled by processors related to an AIS, such as AIS 1102, or can involve modifications like omitting blocks, adding blocks, and/or rearranging the order of execution of the blocks. Process 1100B serves as an example and is not intended to restrict the present disclosure.

At block 1111, an artificial intelligence system (“AIS”), such as AIS 1102 shown and/or described herein, can receive a user input. The user input can include various items of information and be received based on multiple input modalities. For example, user input may indicate one or more of:
one or more tasks for an LLM to perform (e.g., a task description associated with a function).
one or more tools and/or parameters associated with performing the task.
one or more data object types associated with a tool.
one or more actions associated with a selected tool.
a format for a response from the LLM.
a user-defined variable to which an LLM response may be saved.

The AIS can receive the user input via a user interface of a computing device.

At block 1113, the AIS can generate a prompt for an LLM, such as based on the user input. For example, user input may be used by the AIS to identify text content to include in an LLM prompt, such as tool information associated with a tool selected by the user input. The prompt can include a natural language prompt. The AIS can generate the prompt based on at least the user input. The prompt can include context. The prompt can include tool information associated with one or more tools selected by the user. The prompt can include one or more tool implementation examples. The AIS can provide the prompt to the LLM.

At block 1115, the AIS can receive an LLM output. The AIS can receive the LLM output in response to providing the prompt to the LLM. For example, an LLM may process the prompt and generate a response to the prompt which the AIS can receive as the LLM output. The LLM output can include a string of text. The LLM output can include a tool call configured to cause a data processing service to perform one or more tool operations, such as in response to the AIS providing the tool call to the data processing service. In some implementations, the LLM output can comprise a tool call configured to perform a database query. The tool call can be formatted according to tool information included in a prompt generated by the AIS and provided to the LLM.

The AIS can parse the LLM output to change a format of data of the LLM output. The AIS may convert a string of the LLM output to a different data format. In some implementations, the AIS may convert an LLM output data format to a data format defined by an ontology, such as a data object format. The AIS may convert an LLM output, such as text of a tool call including in the LLM output, to a data format that is compatible with a data processing service. Advantageously, reformatting data output from an LLM, such as from one data type to another, may improve the technical field of LLMs such as by providing a system to facilitate integrating the LLM with a data processing service which may greatly expand or enhance the capabilities of LLMs.

At block 1117, the AIS can implement one or more tool operations based on the LLM output. For example, the LLM output may comprise a tool call which may cause the AIS to perform one or more tool operations associated with the tool call. In some implementations, the AIS may query a database based on a tool call in the LLM output. In some implementations, the AIS may process data based on the LLM output, such as filtering and/or aggregating data. In some implementations, the AIS may cause a data processing services to query a database based on the LLM output (e.g., by sending the tool call included in the LLM output to the data processing service via an API call). The database may be external and/or remote to the AIS. The database may be comprised within a same system or device as the AIS.

At block 1119, the AIS may access data based on implementing one or more tool operations, such as data that is returned from a data processing service in response to a tool call sent from the AIS. Thus, accessing the data can include receiving the data from a data processing services. Accessing the data can include retrieving the data from a database. The data can include data structured according to an ontology. The data can include a data object having a data object type and one or more properties.

At block 1121, the AIS may generate a subsequent LLM prompt. The subsequent LLM prompt may comprise the data, or portions thereof, accessed at block 1119 (e.g., an output from a data processing service that was called based on a tool call included in the initial LLM response). The subsequent LLM prompt can include context such as some or all of conversation history, such as some or all of the LLM prompt generated at block 1113 and/or the LLM output at block 1115. In some implementations, the AIS can generate the subsequent LLM prompt based on reformatting the data accessed at block 1119. For example, data accessed at block 1119 may comprise a data object having one or more properties that are formatted according to an ontology. The AIS may reformat the data (e.g., the data object) as a text string that is more easily understandable by the LLM. The AIS may parse the data and extract one or more properties of the data to be formatted as a string. The AIS can provide the subsequent LLM prompt to the LLM.

At block 1123, the AIS can receive a subsequent LLM output. The AIS can receive the subsequent LLM output in response to providing the subsequent prompt to the LLM. For example, an LLM may process the subsequent prompt and generate a response to the subsequent prompt which the AIS can receive as the subsequent LLM output. The subsequent LLM output can include a string of text. The subsequent LLM output can include a response to the user input. In some implementations, the LLM output may not include a tool call. In some implementations, The LLM output can include an additional tool call, which may be executed by the AIS in the same manner as discussed above with reference to blocks 1117-1119.

At block 1125, the AIS can provide a response to the user. The response may include and/or be based on the subsequent LLM output. The AIS may generate the response based on reformatting the LLM output. The AIS can parse the subsequent LLM output to change a format of data of the subsequent LLM output. The AIS may convert a string of the subsequent LLM output to a different data format. In some implementations, the AIS may convert a subsequent LLM output data format to a data format defined by an ontology, such as a data object format, which may be linked to a separate software application for viewing information regarding the data object. The AIS may convert an LLM output to a data format that is compatible with a data processing service. The AIS may convert an LLM output to a data format that is selected by a user. Parsing the subsequent LLM output may improve the usefulness of the subsequent LLM output, such as by rendering the output compatible with a data processing service and/or with a user's purposes to facilitate further manipulating and/or processing the data. Advantageously, reformatting data output from an LLM, such as from one data type to another, may improve the technical field of LLMs such as by providing a system to improve the usefulness of LLM outputs.

### Example Function Testing Methods

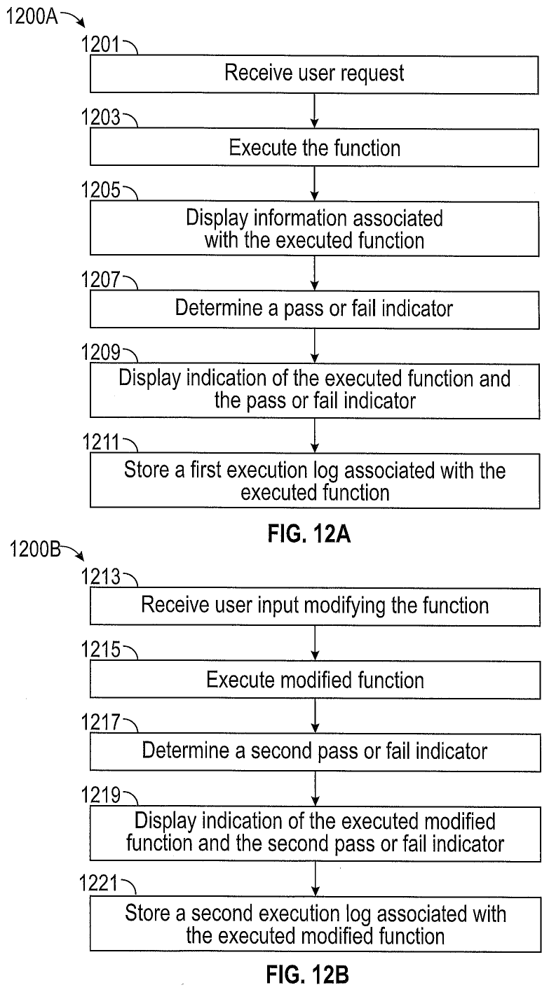

FIGS. 12A and 12B are flowcharts illustrating an example process 1200A and process 1200B for testing functions that utilize interactions with an LLM. Process 1200A and process 1200B may be executed together in one sequence or may be executed singularly. These processes, in full or parts, can be executed by one or more hardware processors, whether in association with a singular or multiple computing devices like user device 1150, AIS 1102, data processing services 1120, LLM 1130, and even devices in remote or wireless communication. The implementations may vary. For example, they could be controlled by processors related to an AIS, such as AIS 1102, or can involve modifications like omitting blocks, adding blocks, and/or rearranging the order of execution of the blocks. Process 1200A and process 1200B serve as examples and are not intended to restrict the present disclosure.

Referring now to FIG. 12A, at block 1201, an artificial intelligence system (“AIS”), such as AIS 1102 shown and/or described herein, can receive a user request to execute a function. As previously described a function can indicate one or more interactions with an LLM to accomplish a task. The user request can include various items of information and be received based on multiple input modalities. For example, user request may indicate one or more of:
one or more tasks for an LLM to perform (e.g., a task description associated with a function).
one or more tools associated with performing the task.
one or more data object types and/or parameters associated with a tool.
one or more actions associated with a selected tool.
a format for a response from the LLM.
a user-defined variable to which an LLM response may be saved.

The AIS can receive the user request via a user interface of a computing device, such as user device 1150.

At block 1203, the AIS can execute the function. Executing the function can include some of, or all of the steps, indicated in FIGS. 11A and 1B. For example, executing the function can utilize function inputs (e.g., task descriptions, tools associated with performing the task, data object types and parameters associated with tools, actions associated with tools, response formats, variables, etc.) to generate one or more prompts for LLM interactions. The AIS may receive one or more responses from an LLM based on the prompts.

At block 1205, the AIS can display information associated with the executed function. For example, the AIS can display the information on a user interface of a computing device, such as user device 1150. The information can include at least some of the prompt sent to the LLM and a response received from the LLM. The information can also include function inputs, such as the task description and data inputs used to generate the prompt.

At block 1207, the AIS determines a pass or fail indicator based on an analysis of the function with one or more validation tests. As previously described, to determine if a function passes a validation test, the AIS can compare an outcome from the execution of the function (e.g., a prompt, a response received from an LLM, a tool call, etc.) to a validation test result and determine if the outcome and the validation test result are equivalent. In some embodiments, the AIS determines the equivalence via a user comparing the outcome and the validation test result and indicating the outcome and validation test results are equivalent. In some embodiments, the AIS determines the equivalence by using one or more models. For example, the AIS may ask an LLM to rate how similar the outcome is to the validation test result. When a validation test is passed the AIS can determine the pass indicator. Otherwise, the AIS will determine a fail indicator.

At block 1209, the AIS displays an indication of the executed function and the pass or fail indicator. For example, the system can update the user interface of the user computing device to include the indication of the executed function and the pass or fail indicator.

At block 1211, the AIS stores a first execution log associated with the executed function. As previously described, an execution log may include a record of the various function inputs, prompts, and responses received from an LLM during the execution of a function. An execution log may record a single interaction of the AIS and an LLM during the execution of the function or may record multiple interactions of the AIS and an LLM during the execution of the function. When the execution log includes multiple interactions with an LLM, the execution log may also include sub-execution logs of the individual interactions with the LLM.

In some instances, the AIS stores the first execution log in response to a fail indicator. For example, the AIS may generate and store the first execution log in response to the function failing one or more validation tests. In other instances, the AIS may generate and store the first execution log each time a function is executed. The first execution log may include a record of every function input, prompt, and response received from an LLM during the execution of the function or may include a reduced record. For example, the first execution log may include a reduced record of only the function inputs, prompts and responses received from an LLM associated with a fail indicator.

Referring now to FIG. 12B, process 1200B may be performed by the AIS in response to, or in continuation of process 200A. Process 1200B may also be performed separately than process 1200A. At block 1213, the AIS receives one or more user inputs modifying a function. For example, the AIS can receive user inputs modifying at one or more of:
one or more tasks for an LLM to perform (e.g., a task description associated with a function).
one or more tools associated with performing the task.
one or more data object types and/or parameters associated with a tool.
one or more actions associated with a selected tool.
a format for a response from the LLM.
a user-defined variable to which an LLM response may be saved.

The AIS can receive the user inputs via a user interface of a computing device, such as user device 1150.

At block 1215, the AIS can execute the modified function. Executing the modified function can include some of, or all of the steps, indicated in FIGS. 11A and 11B. For example, executing the modified function can utilize function inputs (e.g., task descriptions, tools associated with performing the task, data object types and parameters associated with tools, actions associated with tools, response formats, variables, etc.) to generate one or more prompts for LLM interactions. The AIS may receive one or more responses from an LLM based on the prompts.

At block 1217, the AIS determines a second pass or fail indicator based on an analysis of the modified function with one or more validation tests. The analysis may be the same as described with respect to block 1207 of FIG. 12A. The AIS may utilize the same validation tests to analyze the modified function as were used to analyze the original function described in FIG. 12A. In some instances, the second pass or fail indicator can indicate whether the modifications to the function altered the analysis of the function. For example, the function described in FIG. 12A, may have been associated with a fail indicator. In this example, if the modified function is associated with a pass indicator, the modification may have caused the modified function to pass a previously failing validation test.

At block 1219, the AIS displays an indication of the executed modified function and the second pass or fail indicator. For example, the system can update the user interface of the user computing device to include the indication of the executed modified function and the second pass or fail indicator.

At block 1221, the AIS stores a second execution log associated with the executed modified function. The second execution log may include all the components described with respect to block 1211 of FIG. 12A. In some instances, the AIS stores the second execution log in response to a fail indicator. For example, the AIS may generate and store the second execution log in response to the modified function failing one or more validation tests. In other instances, the AIS may generate and store the second execution log each time a modified function is executed. The second execution log may include a record of every function input, prompt, and response received from an LLM during the execution of the modified function or may include a reduced record. For example, the second execution log may include a reduced record of only the modified unction inputs, prompts and responses received from an LLM associated with a fail indicator.

### Example Validation Test Generation Methods

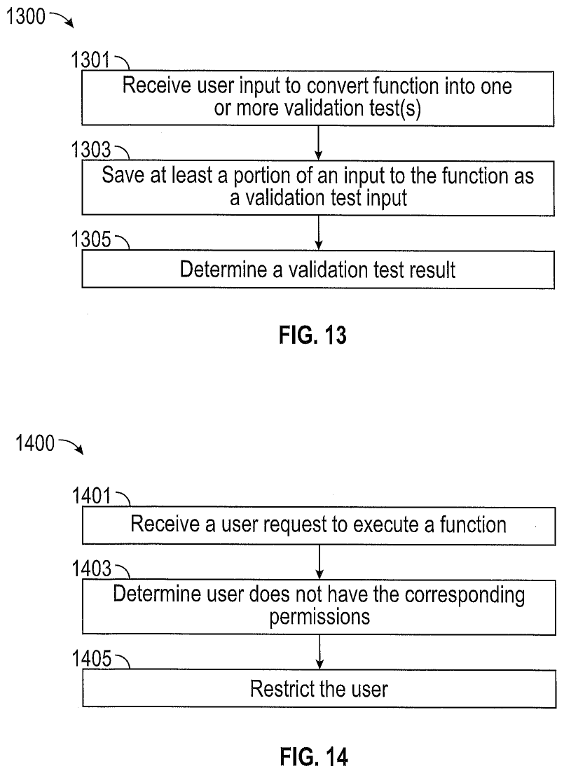

FIG. 13 is a flowchart illustrating an example process 1300 for generating a validation test from a function. Process 1300, in full or parts, can be executed by one or more hardware processors, whether in association with a singular or multiple computing devices like user device 1150, AIS 1102, data processing services 1120, LLM 1130, and even devices in remote or wireless communication. The implementations may vary. For example, the implementations of process 1300 can be controlled by processors related to an AIS, such as AIS 1102, or can involve modifications such as omitting blocks, adding blocks, and/or rearranging the order of execution of the blocks. Process 1300 serves as examples and is not intended to restrict the present disclosure.

At block 1301, an artificial intelligence system (“AIS”), such as AIS 1102 shown and/or described herein, can receive one or more user inputs converting a function into one or more validation tests. As previously described, to convert a function into a validation test, a user may select one or more execution logs of the function to convert into the validation test. A user may select specific portions of an execution log and enter one or more additional inputs to convert into the validation test. For example, a user may select specific portion of an execution log as validation test inputs and validation test results and/or may enter one or more additional inputs as validation test inputs and validation test results.

At block 1303, the AIS saves at least a portion of an input to the function as a validation test input. As previously described, the validation test inputs may be predetermined values for some of the function inputs (e.g., the task description, data inputs, tools, etc.). The AIS may save a portion of the function inputs in the execution log. For example, the AIS may save a portion of the description of the tasks and/or the tools, tool parameters, object types, and/or data inputs used in the execution log as validation test inputs. The AIS save the portion of the function inputs based on the one or more user inputs received at block 1301. For example, a user may selected a portion of the description of the tasks and/or the tools, tool parameters, object types, and/or data inputs used in the execution log and the system can save the user selection as the validation test inputs of a validation test.

At block 1305, the AIS determines a validation test result. As previously described, the validation test results can be a predetermined outcome that is expected to occur given the validation test inputs. To determine the validation test results for the validation test, the AIS determines a result that should occur based on the validation test inputs. For example, the AIS may determine for a task of “scheduling maintenance for the oldest piece of equipment” that the function schedule maintenance at a time for a specific piece of equipment. In some embodiments, the AIS determines the validation test results for a validation test based on one or more user inputs entering a desired result. For example, the one or more user inputs received at block 1301 can include one or more user inputs entering a desired result.

### Example Methods for Utilizing Permissions

FIG. 14 is a flowchart illustrating an example process 1400 for restricting a user based on permissions. Process 1400, in full or parts, can be executed by one or more hardware processors, whether in association with a singular or multiple computing devices like user device 1150, AIS 1102, data processing services 1120, LLM 1130, and even devices in remote or wireless communication. The implementations may vary. For example, the implementations of process 1400 can be controlled by processors related to an AIS, such as AIS 1102, or can involve modifications such as omitting blocks, adding blocks, and/or rearranging the order of execution of the blocks. Process 1300 serves as examples and is not intended to restrict the present disclosure.

At block 1401, an artificial intelligence system (“AIS”), such as AIS 1102 shown and/or described herein, can receive a user request to execute a function. As previously described a function can indicate one or more interactions with an LLM to accomplish a task. The user request can include various items of information and be received based on multiple input modalities. For example, user request may indicate one or more of:
one or more tasks for an LLM to perform (e.g., a task description associated with a function).
one or more tools associated with performing the task.
one or more data object types and/or parameters associated with a tool.
one or more actions associated with a selected tool.
a format for a response from the LLM.
a user-defined variable to which an LLM response may be saved.

The AIS can receive the user request via a user interface of a computing device, such as user device 1150.

At block 1403, the AIS can determine the user does not have the corresponding permissions used to access respective data sources, other function inputs, and or the function. As previously described, functions and function inputs (such as the inputs indicated above) may have sets of rules, such as permissions, constraints, qualifications, authorizations, security markings, access controls, and the like (generally referred to herein as “permissions”) that govern the access to each function or function input. In order to access or execute a function and/or function input, a user may need to have the permissions associated with the function or function input. For example, a particular data input may contain confidential information. In this example the particular data input may be associated with a permission such that only a user with the permission can access or cause the system to access the confidential information in the data input or view the data input in the execution log.

A permission may be associated with different scopes. For instance, a permission can be applied to portions of data inputs (e.g., a data source that is accessed via a tool), such as individual data values, ranges of data values, columns of data values, rows of data values, tabs, and other portions of a data input or a combination thereof. A permission can also be applied to an entire data input or multiple data inputs. In some embodiments, a permission may be applied to one or more entire data inputs or one or more portions of data inputs. Similarly, permission can be applied to individual tools or object types or multiple functions or object types, classes of functions or object types, libraries of functions, database of object types, and the like.

The permissions applied to the functions and/or function inputs may be applied to one or more responses received from an LLM. In this way, all of the permissions required to access the functions and/or function inputs used to generate a prompt are also required to access the response to the prompt. The permissions applied to the functions and/or function inputs may be tracked and applied to portions of the execution log. As such, all, or a portion, of an execution log may be restricted from a user without the required permissions. For example, a user without the required permissions may be restricted or otherwise prevented from viewing portions of function inputs, prompts, and/or LLM responses in an execution log.

When a function is converted into a validation test, any permissions associated with the function or function input may be applied to the validation test. As such, secured information used in the execution of the function remains secured in the validation test. For example, the permissions on the function or function inputs used in the execution of a function can be applied to the validation test inputs, the validation test results, and/or any intermediate data inputs, prompts, and LLM responses of a validation test.

The AIS may determine the permissions required to access the function, and/or the function inputs and determine a level of permission associated with the user. The AIS system can compare the determined user permissions with the permissions associated with the function and/or function inputs. If the user permissions do not match, the system can determine the user does not have the corresponding permissions used to access respective data sources, other function inputs, or the function.

At block 1405, the AIS restricts the user. For example, the AIS may prevent the user from executing the function. In another example, the user can execute the function but may be restricted or otherwise prevented from viewing portions of function inputs, prompts, and/or LLM responses in an execution log of the function.

In some embodiments, a user may request one or more permissions be removed or temporarily disabled. In some embodiments, when the system receives a request that a permission is to be removed or temporarily disabled, the system requests confirmation for a user with the authority over the permission (e.g., the owner of the confidential information).

### Example User Interfaces

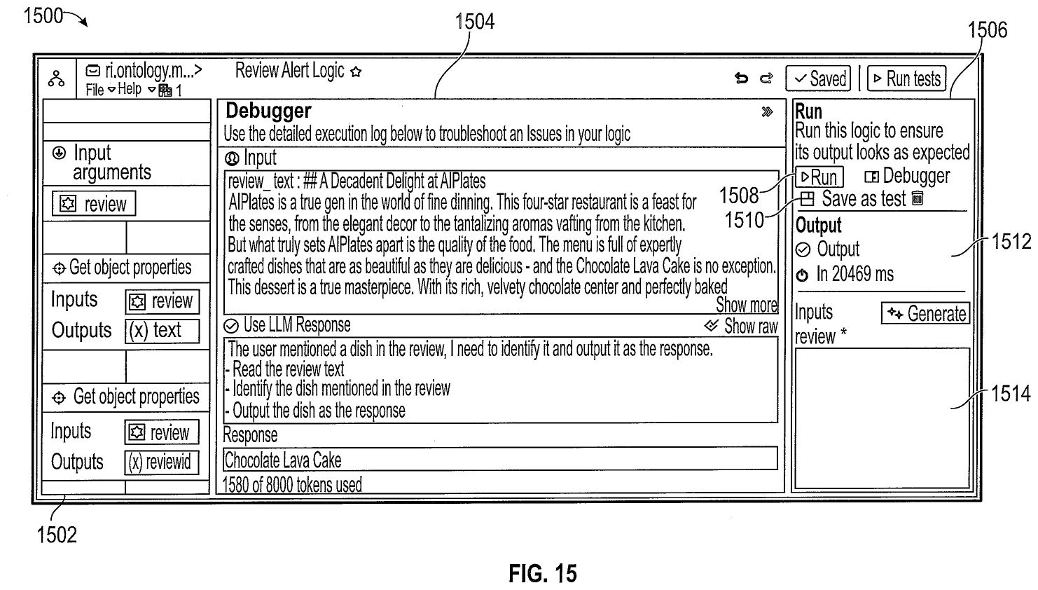

In some embodiments, the artificial intelligence system may include or provide for a graphical user interfaces for testing functions and generating validation tests (also referred to as “unit tests”). FIG. 15 illustrates an example user interface 1500 showing a function testing interface with a rich view. In this example, the user interface 1500 includes a function input pane 1502, a debugger pane 1504, and a validation test pane 1506.

The function input pane 1502 enables a user to set up a function. For example, the function input pane 1502 can enable a user to enter and/or select function inputs, such as task descriptions (also referred to as “input arguments”), data inputs, tools, tool parameters, data objects, object properties, etc. to set up a function. The components of the function input pane 1502 may be utilized by the system to generate and/or modify LLM prompts.

The debugger pane 1504 contains a rich view of all interactions (also referred to as a “conversation”) between the artificial intelligence system and an LLM. For example, the debugger pane 1504 can be used to view the function inputs, prompts, and LLM responses associated with one or more interactions with an LLM.

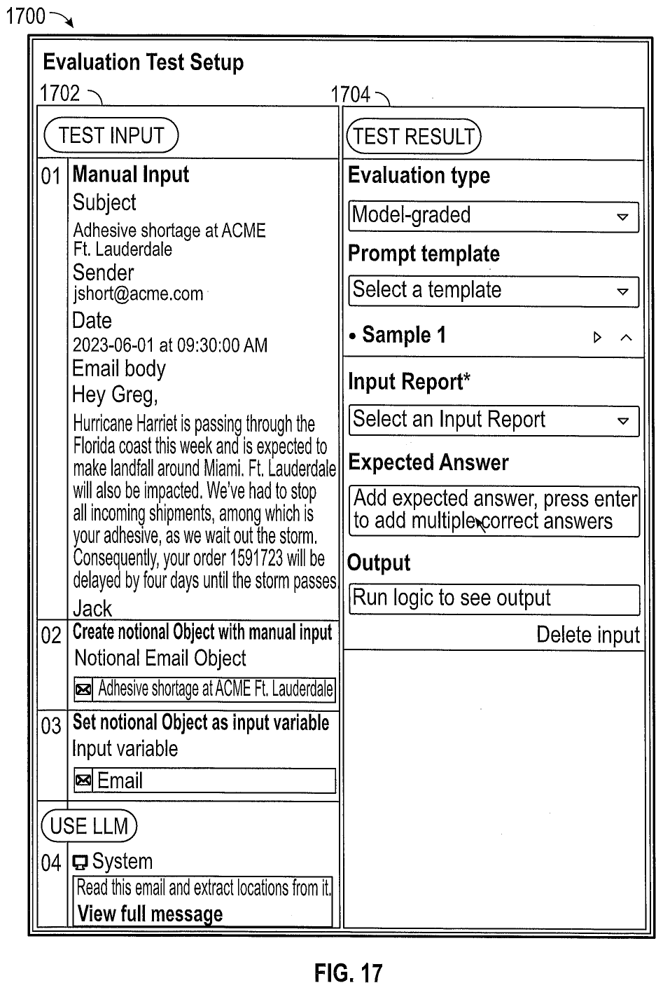

The validation test pane 1508 enables a user to set up, run, and view results of one or more validation tests for the function. In the illustrated example, the validation test pane 1508 includes a run selection 1508, a save selection 1510, a validation test output subpanel 1512, and an input summary subpanel 1514. Using the run selection 1508, a user can run a configured validation test. Using the save selection 1510, a user can save all of, or a portion of the current function as a validation test. In some embodiments, the save selection 1510 takes a user into a separate user interface, such as user interface 1700 described with reference to FIG. 17. Using the validation test output subpanel 1512, a user can view information about validation tests that have been run for the function. For example, the validation test output subpanel 1512 can display the indication of an executed function and the pass or fail indicators described with reference to block 1209 of FIG. 12A and block 1219 of FIG. 12B. The input summary subpanel 1514 can provide a view of the function inputs and/or prompts used in the a validation test run. For example, the input summary subpanel 1514 can be used to view the validation test inputs used for the validation test.

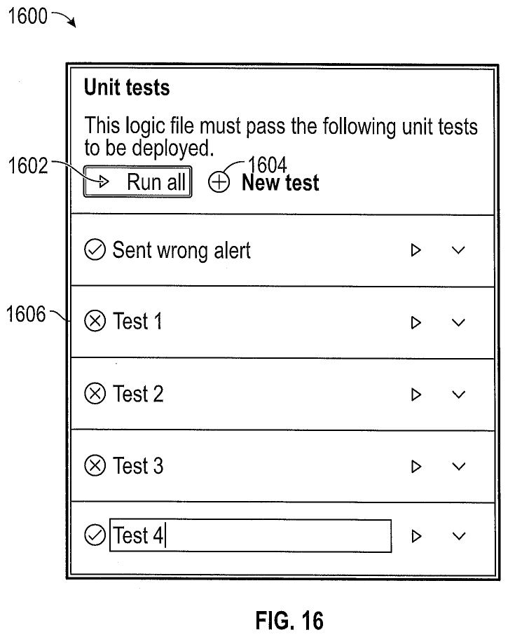

FIG. 16 illustrates an example user interface 1600 showing a summary of configured validation tests associated with a function. In this example, the user interface 1600 includes a run all selection 1602, a configure new test selection 1604, and validation test list 1606. Using the run all selection 1602, a user can run all configured validation tests to determine if the function passes each validation test. Using the new test selection 1604, a user can configure a new validation test. In some embodiments, using the new test selection 1604 takes a user into a separate user interface, such as user interface 1700 described with reference to FIG. 17.

The validation test list 1606 provides a listing of each validation test configured for the function. Each validation test in the listing includes a name of the validation test. The name of the validation test can be changed by the user. Each validation test in the listing includes a pass or fail indicator indicating the result of the last run of the validation test for the function. For example, a fail indicator indicates that the last run of the validation test resulted in the function failing the validation test. Each validation test in the listing can include selections a user can utilize to run the validation test individually and/or reconfigure the validation test.

FIG. 17 illustrates an example user interface 1700 showing evaluation test setup. In this example, the user interface 1700 includes a validation test input pane 1702 and a validation test result pane 1704. Using the validation test input pane 1702, a user can setup the validation test inputs used for the validation test. For example, a user can select one or more function inputs from an execution log and/or manually enter function inputs to be used as validation test inputs. In the illustrated example, the test input pane 1702 includes a manual input of email data, a call to a tool to “create notional Object with manual input,” a call to a tool to “set notional Object as input variable,” and a task description to “Read this email and extract locations from it.”

Using the validation test result pane 1704, a user can setup the validation test result used for the validation test. A user can utilize the validation test result pane 1704 to select an evaluation type. The evaluation type can define how the artificial intelligence system determines the validation test was passed or failed. For example, the evaluation type can be model-graded. In some instances, a model-graded evaluation type utilizes one or more models to compare the function outcome to the validation test result and to determine if the function outcome satisfies the validation test result. In a non-limiting example, a model may be asked to compare the function outcome and the validation test result and give a similarity rating. While the illustrated example shows the evaluation type as model graded, a validation test may utilize other evaluation types. For example, the evaluation type may be set to user confirmation. In this example, a user interface may display the function outcome and the user may be prompted to accept or reject the outcome.

A user can utilize the test result pane 1704 to select a prompt template. The prompt template may configure the type of evaluation done to the function outcome. For example, a prompt template that is set to “fact” may parse the function outcome and determine whether factual equivalence to a validation test response, whether the function outcome is a factual subset of the validation test response, whether the function outcome is a factual superset of the validation test response, and/or another logical or other factual relation between the function outcome and the validation test response.

A user can utilize the test result pane 1704 to configure a validation test result (also referred to as an “expected answer”). The validation test result can be selected or manually entered. In some embodiments, the validation test result includes a sample of a data that a model can use to compare to the function result. Multiple validation test results can be added. For example, the function may include multiple interactions with an LLM to be tested and/or may test various stages of the execution of a function, such as testing both a prompt generation and a response received from an LLM.

### Additional Implementation Details and Embodiments

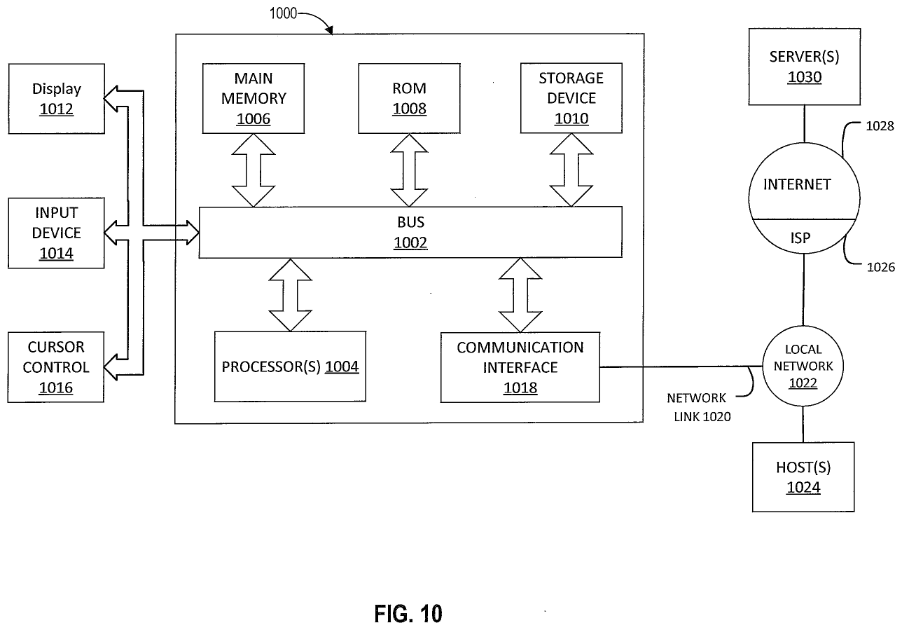

In an implementation of the system (e.g., one or more aspects of the automatic correction system 102 (FIG. 1), the AI system 1102 (FIG. 11A), and/or one or more aspects of the computing environments illustrated in the figures, such as in FIGS. 1 and 11A, and/or the like) may comprise, or be implemented in, a “virtual computing environment”. As used herein, the term “virtual computing environment” should be construed broadly to include, for example, computer-readable program instructions executed by one or more processors (e.g., as described in the example of FIG. 10) to implement one or more aspects of the modules and/or functionality described herein. Further, in this implementation, one or more services/modules/engines and/or the like of the system may be understood as comprising one or more rules engines of the virtual computing environment that, in response to inputs received by the virtual computing environment, execute rules and/or other program instructions to modify operation of the virtual computing environment. For example, a request received from a user computing device may be understood as modifying operation of the virtual computing environment to cause the request access to a resource from the system. Such functionality may comprise a modification of the operation of the virtual computing environment in response to inputs and according to various rules. Other functionality implemented by the virtual computing environment (as described throughout this disclosure) may further comprise modifications of the operation of the virtual computing environment, for example, the operation of the virtual computing environment may change depending on the information gathered by the system. Initial operation of the virtual computing environment may be understood as an establishment of the virtual computing environment. In some implementations the virtual computing environment may comprise one or more virtual machines, containers, and/or other types of emulations of computing systems or environments. In some implementations the virtual computing environment may comprise a hosted computing environment that includes a collection of physical computing resources that may be remotely accessible and may be rapidly provisioned as needed (commonly referred to as “cloud” computing environment).

Implementing one or more aspects of the system as a virtual computing environment may advantageously enable executing different aspects or modules of the system on different computing devices or processors, which may increase the scalability of the system. Implementing one or more aspects of the system as a virtual computing environment may further advantageously enable sandboxing various aspects, data, or services/modules of the system from one another, which may increase security of the system by preventing, e.g., malicious intrusion into the system from spreading. Implementing one or more aspects of the system as a virtual computing environment may further advantageously enable parallel execution of various aspects or modules of the system, which may increase the scalability of the system. Implementing one or more aspects of the system as a virtual computing environment may further advantageously enable rapid provisioning (or de-provisioning) of computing resources to the system, which may increase scalability of the system by, e.g., expanding computing resources available to the system or duplicating operation of the system on multiple computing resources. For example, the system may be used by thousands, hundreds of thousands, or even millions of users simultaneously, and many megabytes, gigabytes, or terabytes (or more) of data may be transferred or processed by the system, and scalability of the system may enable such operation in an efficient and/or uninterrupted manner.

Various implementations of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure. Computer-readable storage mediums may also be referred to herein as computer-readable storage or computer-readable storage devices.

The computer-readable storage medium can be a tangible device that can retain and store data and/or instructions for use by an instruction execution device. The computer-readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions (as also referred to herein as, for example, “code,” “instructions,” “module,” “application,” “software application,” “service,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer-readable program instructions may be callable from other instructions or from itself, and/or may be invoked in response to detected events or interrupts. Computer-readable program instructions configured for execution on computing devices may be provided on a computer-readable storage medium, and/or as a digital download (and may be originally stored in a compressed or installable format that requires installation, decompression, or decryption prior to execution) that may then be stored on a computer-readable storage medium. Such computer-readable program instructions may be stored, partially or fully, on a memory device (e.g., a computer-readable storage medium) of the executing computing device, for execution by the computing device. The computer-readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart(s) and/or block diagram(s) block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowcharts and block diagrams in the Figures illustrate the architecture, functionality, and operation of possible implementations of systems, methods, and computer program products according to various implementations of the present disclosure. In this regard, each block in the flowchart or block diagrams may represent a service, module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted or optional in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, and/or the like with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above implementations may generally (but not necessarily) be controlled and/or coordinated by operating system software, such as Mac OS, IOS, Android, Chrome OS, Windows OS (e.g., Windows XP, Windows Vista, Windows 7, Windows 8, Windows 10, Windows 11, Windows Server, and/or the like), Windows CE, Unix, Linux, SunOS, Solaris, Blackberry OS, VxWorks, or other suitable operating systems. In other implementations, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

For example, FIG. 10 shows a block diagram that illustrates a computer system 1000 upon which various implementations and/or aspects (e.g., one or more aspects of the computing environments illustrated in FIG. 1 or 11A, for example, one or more aspects of the automatic correction system 102, the AI system 1102, one or more aspects of the user 150 or 11150, one or more aspects of the data processing service 120 or 1120, one or more aspects of the LLMs 130a, 130b, 1130, and/or the like) may be implemented. Multiple such computer systems 1000 may be used in various implementations of the present disclosure. Computer system 1000 includes a bus 1002 or other communication mechanism for communicating information, and a hardware processor, or multiple processors, 1004 coupled with bus 1002 for processing information. Hardware processor(s) 1004 may be, for example, one or more general purpose microprocessors.

Computer system 1000 also includes a main memory 1006, such as a random-access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions. The main memory 1006 may, for example, include instructions to implement server instances, queuing modules, memory queues, storage queues, user interfaces, and/or other aspects of functionality of the present disclosure, according to various implementations.

Computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), and/or the like, is provided and coupled to bus 1002 for storing information and instructions.

Computer system 1000 may be coupled via bus 1002 to a display 1012, such as a cathode ray tube (CRT) or LCD display (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. In some implementations, the same direction information and command selections as cursor control may be implemented via receiving touches on a touch screen without a cursor.

Computer system 1000 may include a user interface module to implement a GUI that may be stored in a mass storage device as computer executable program instructions that are executed by the computing device(s). Computer system 1000 may further, as described below, implement the techniques described herein using customized hard-wired logic, one or more ASICs or FPGAs, firmware and/or program logic which in combination with the computer system causes or programs computer system 1000 to be a special-purpose machine. According to one implementation, the techniques herein are performed by computer system 1000 in response to processor(s) 1004 executing one or more sequences of one or more computer-readable program instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative implementations, hard-wired circuitry may be used in place of or in combination with software instructions.

Various forms of computer-readable storage media may be involved in carrying one or more sequences of one or more computer-readable program instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN (or WAN component to communicated with a WAN). Wireless links may also be implemented. In any such implementation, communication interface 1018 sends and receives electrical, electromagnetic, or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic, or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

As described above, in various implementations certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain implementations, one or more of the computing devices and/or systems of the disclosure may include mobile computing devices, and user interfaces may be accessible through such mobile computing devices (for example, smartphones and/or tablets).

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

### Example Clauses

Examples of implementations of the present disclosure can be described in view of the following example clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

Clause 1. A computerized method, performed by a computing system having one or more hardware computer processors and one or more non-transitory computer readable storage device storing software instructions executable by the computing system to perform the computerized method comprising: receiving, via a user interface, from a user a first user input for a large language model (“LLM”); generating, based on the first user input, a first prompt; transmitting the first prompt to the LLM; receiving an output from the LLM; evaluating the output from the LLM with reference to one or more validation tests; responsive to determining that the output from the LLM is not validated, generating a second prompt for the LLM, wherein the second prompt indicates at least an aspect of the output that caused the output to not be validated; transmitting the second prompt to the LLM; and receiving an updated output from the LLM.

Clause 2. The computerized method of claim 1, wherein the one or more validation tests include validation tests configured to validate format of information in the output; type of information in the output; and/or business rules associated with the information in the output.

Clause 3. The computerized method of claim 1, further comprising: evaluating the updated output from the LLM with reference to the one or more validation tests; and responsive to determining that the updated output from the LLM is validated, providing the updated output via the user interface.

Clause 4. The computerized method of claim 1, further comprising: automatically generating, based at least in part on the first prompt, the one or more validation tests for validating the output and the updated output from the LLM.

Clause 5. The computerized method of claim 1 further comprising: responsive to determining that the updated output from the LLM is not validated, generating a third prompt for the LLM, wherein the third prompt indicates at least an aspect of the updated output that caused the updated output to not be validated.

Clause 6. The computerized method of claim 1, wherein the one or more validation tests comprise at least one of a syntax-based rule, a semantic rule, a formality-based rule, a character-based rule, an object-based rule, or a tool-based rule.

Clause 7. The computerized method of claim 1, wherein the one or more validation tests comprise a model, and wherein the output and the updated output are transmitted to the model for evaluation.

Clause 8. The computerized method of claim 7, wherein the model is one of a language model, an AI model, a generative model, a machine learning (“ML”) model or a neural network (“NN”).

Clause 9. The computerized method of claim 1, wherein the one or more validation tests are generated further based on a profile or an identity of the user.

Clause 10. The computerized method of claim 1, wherein the second prompt identifies that an object type associated with the output from the LLM is invalid, a tool associated with the output from the LLM is not available, or an item associated with the output from the LLM does not exist.

Clause 11. The computerized method of claim 1, wherein the second prompt is generated at least based on a template.

Clause 12. The computerized method of claim 11, wherein the template is selected based on a type of the one or more validation tests that caused the output to not be validated.

Clause 13. The computerized method of claim 11, wherein the template includes an example of valid information associated with the one or more validation tests.

Clause 14. The computerized method of claim 1, further comprising: transmitting ontology data to the LLM, wherein the one or more validation tests or the second prompt refer to the ontology data.

Clause 15. A system for managing one or more models, the system comprising: one or more processors; and a memory that stores computer-executable instructions, wherein the computer-executable instructions, when executed, cause the one or more processors to: receive, via a user interface, from a user a first user input for a large language model (“LLM”); generate, based on the first user input, a first prompt; transmit the first prompt to the LLM; receive an output from the LLM; evaluate the output from the LLM with reference to one or more validation tests; responsive to determining that the output from the LLM is not validated, generate a second prompt for the LLM, wherein the second prompt indicates at least an aspect of the output that caused the output to not be validated; transmit the second prompt to the LLM; and receive an updated output from the LLM.

Clause 16. The system of claim 15, wherein the computer-executable instructions, when executed, further cause the one or more processors to: evaluate the updated output from the LLM with reference to the one or more validation tests; and responsive to determining that the updated output from the LLM is validated, provide the updated output via the user interface.

Clause 17. The system of claim 15, wherein the one or more validation tests include validation tests configured to validate format of information in the output; type of information in the output; and/or business rules associated with the information in the output.

Clause 18. The system of claim 15, wherein the computer-executable instructions, when executed, further cause the one or more processors to: automatically generate, based at least in part on the first prompt, the one or more validation tests for validating the output and the updated output from the LLM.

Clause 19. One or more non-transitory computer-readable media comprising computer-executable instructions for managing one or more models, wherein the computer-executable instructions, when executed by a computer system, cause the computer system to perform operations comprising: receiving, via a user interface, from a user a first user input for a large language model (“LLM”); generating, based on the first user input, a first prompt; transmitting the first prompt to the LLM; receiving an output from the LLM; evaluating the output from the LLM with reference to one or more validation tests; responsive to determining that the output from the LLM is not validated, generating a second prompt for the LLM, wherein the second prompt indicates at least an aspect of the output that caused the output to not be validated; transmitting the second prompt to the LLM; and receiving an updated output from the LLM.

Clause 20. The one or more non-transitory computer-readable media of claim 19, wherein the computer-executable instructions, when executed by the computer system, further cause the computer system to: evaluate the updated output from the LLM with reference to the one or more validation tests; and responsive to determining that the updated output from the LLM is validated, provide the updated output via the user interface.

Clause 21. A computer program product comprising one or more computer-readable storage mediums having program instructions embodied therewith, the program instructions executable by one or more processors to cause the one or more processors to perform the computerized method of any of Clauses 1-14.

Clause 22. A computerized method, performed by a computing system having one or more hardware computer processors and one or more non-transitory computer readable storage device storing software instructions executable by the computing system to perform the computerized method comprising: receiving a request from a user of the computing system to execute a function, wherein the function indicates one or more interactions with a large language model (LLM); executing the function; displaying, in a user interface, information associated with the executed function, the information including at least some of a prompt sent to the LLM and a response received from the LLM; determining, based on analysis of at least the response from the LLM with reference to one or more validation tests, a pass or fail indicator; updating the user interface to include an indication of the executed function and the pass or fail indicator; storing a first execution log associated with the executed function, the first execution log indicating at least the prompt and the response; receiving, via the user interface, one or more inputs from the user modifying the function; executing the modified function; determining, based on analysis of at least a second response from the LLM with reference to the one or more validation tests, a second pass or fail indicator; updating the user interface to include an indication of the executed modified function and the second pass or fail indicator; storing a second execution log associated with the executed modified function, the second execution log indicating at least a second prompt and the second response.

Clause 23. The computerized method of Clause 22, wherein the user modifying the function includes at least one of: a modification to a natural language prompt associated with the request from the user; a modification of one or more tools used in executing the function; a modification to a parameter associated with the one or more tools; a modification of one or more object types used in executing the function; and a modification of one or more data inputs used in executing the function.

Clause 24. The computerized method of any of Clauses 22-23, further comprising: receiving a request from the user of the computing system to convert the function or the modified function into a first validation test of the one or more validation tests; and converting the function or the modified function into the first validation test.

Clause 25. The computerized method of Clause 24, wherein converting the function or the modified function into the first validation test comprises: saving at least a portion of an input to the function or the modified function as a validation test input, wherein the input to the function or the modified function comprises: a natural language prompt associated with the request from the user, one or more tools used in executing the function or the modified function, parameters associated with the one or more tools, one or more object types used in executing the function or the modified function, and one or more data inputs used in executing the function; and determining a validation test result.

Clause 26. The computerized method of Clause 25, wherein determining the validation test result comprises receiving one or more user inputs defining at least a portion of the validation test.

Clause 27. The computerized method of any of Clauses 25-26, wherein analysis of at least the response from the LLM with reference to one or more validation tests comprises at least one of: comparing the response from the LLM to the validation test result using one or more LLMs; or receiving one or more user inputs accepting the response.

Clause 28. The computerized method of any of Clauses 22-27, wherein the first execution log is stored based on the determining of the fail indicator and the second execution log is stored based on the determining of the second fail indicator.

Clause 29. The computerized method of any of Clauses 22-28, wherein the first execution log and the second execution log are accessible to one or more other computing systems based on permissions.

Clause 30. The computerized method of any of Clauses 22-29, wherein the first execution log indicates a user provided input and a system generated input that are each included in the prompt.

Clause 31. The computerized method of any of Clauses 22-30, wherein the first execution log indicates one or more data sources accessed by the function and corresponding permissions used to access respective data sources.

Clause 32. The computerized method of Clause 31, wherein the corresponding permissions comprise: one or more permissions associated with the user of the computing system; and one or more permissions required to access the respective data sources.

Clause 33. The computerized method of any of Clauses 31-32, further comprising: receiving a request to execute the function from a second user of the computer system; determining the second user does not have the corresponding permissions used to access respective data sources; and restricting the second user.

Clause 34. The computerized method of Clause 33, wherein restricting the second user comprises at least one of: preventing the function from executing; or limiting the second user from accessing at least a portion of the first execution log or the second execution log.

Clause 35. The computerized method of any of Clauses 31-35, further comprising: displaying, in the user interface, a request to remove a first permission of the permissions used to access respective data sources; receiving one or more user inputs confirming the request to remove the first permission; and removing the first permission from the first execution log.

Clause 36. The computerized method of any of Clauses 22-36, wherein the function comprises two or more interactions with the LLM, each interaction including transmission of a prompt to the LLM and receiving a response from the LLM.

Clause 37. The computerized method of Clause 36, wherein the prompt of at least one interaction of the two or more interactions is based at least in part on the response from the LLM received in a second interaction of the two or more interactions.

Clause 38. The computerized method of any of Clauses 22-37, wherein the one or more validation tests comprise an overall validation test and a plurality of sub-validation tests.

Clause 39. The computerized method of Clause 38, wherein each of the plurality of sub-validation tests is used to analyze one interaction with the LLM and the overall validation test is used to analyze two or more interactions with the LLM.

Clause 40. A system comprising: a computer readable storage medium having program instructions embodied therewith; and one or more processors configured to execute the program instructions to cause the system to perform the computerized method of any of Clauses 22-39.

Clause 41. A computer program product comprising a computer-readable storage medium having program instructions embodied therewith, the program instructions executable by one or more processors to cause the one or more processors to perform the computerized method of any of Clauses 22-39.

What is claimed is:

1. A computerized method, performed by a computing system having one or more hardware computer processors and one or more non-transitory computer readable storage device storing software instructions executable by the computing system to perform the computerized method comprising:
receiving, via a user interface, from a user a first user input for a large language model (“LLM”);
generating, based on the first user input, a first prompt;
transmitting the first prompt to the LLM;
receiving an output from the LLM;
evaluating the output from the LLM with reference to one or more validation tests;
responsive to determining that the output from the LLM is not validated, generating a second prompt for the LLM, wherein the second prompt indicates at least an aspect of the output that caused the output to not be validated;
transmitting the second prompt to the LLM; and
receiving an updated output from the LLM.

2. The computerized method of claim 1, wherein the one or more validation tests include validation tests configured to validate format of information in the output; type of information in the output; and/or business rules associated with the information in the output.

3. The computerized method of claim 1, further comprising:
evaluating the updated output from the LLM with reference to the one or more validation tests; and
responsive to determining that the updated output from the LLM is validated, providing the updated output via the user interface.

4. The computerized method of claim 1, further comprising:
automatically generating, based at least in part on the first prompt, the one or more validation tests for validating the output and the updated output from the LLM.

5. The computerized method of claim 1 further comprising:
responsive to determining that the updated output from the LLM is not validated, generating a third prompt for the LLM, wherein the third prompt indicates at least an aspect of the updated output that caused the updated output to not be validated.

6. The computerized method of claim 1, wherein the one or more validation tests comprise at least one of a syntax-based rule, a semantic rule, a formality-based rule, a character-based rule, an object-based rule, or a tool-based rule.

7. The computerized method of claim 1, wherein the one or more validation tests comprise a model, and wherein the output and the updated output are transmitted to the model for evaluation.

8. The computerized method of claim 7, wherein the model is one of a language model, an AI model, a generative model, a machine learning (“ML”) model or a neural network (“NN”).

9. The computerized method of claim 1, wherein the one or more validation tests are generated further based on a profile or an identity of the user.

10. The computerized method of claim 1, wherein the second prompt identifies that an object type associated with the output from the LLM is invalid, a tool associated with the output from the LLM is not available, or an item associated with the output from the LLM does not exist.

11. The computerized method of claim 1, wherein the second prompt is generated at least based on a template.

12. The computerized method of claim 11, wherein the template is selected based on a type of the one or more validation tests that caused the output to not be validated.

13. The computerized method of claim 11, wherein the template includes an example of valid information associated with the one or more validation tests.

14. The computerized method of claim 1, further comprising:
transmitting ontology data to the LLM, wherein the one or more validation tests or the second prompt refer to the ontology data.

15. A system for managing one or more models, the system comprising:
one or more processors; and
a memory that stores computer-executable instructions, wherein the computer-executable instructions, when executed, cause the one or more processors to:
receive, via a user interface, from a user a first user input for a large language model (“LLM”);
generate, based on the first user input, a first prompt;
transmit the first prompt to the LLM;
receive an output from the LLM;
evaluate the output from the LLM with reference to one or more validation tests;
responsive to determining that the output from the LLM is not validated, generate a second prompt for the LLM, wherein the second prompt indicates at least an aspect of the output that caused the output to not be validated;
transmit the second prompt to the LLM; and
receive an updated output from the LLM.

16. The system of claim 15, wherein the computer-executable instructions, when executed, further cause the one or more processors to:
evaluate the updated output from the LLM with reference to the one or more validation tests; and
responsive to determining that the updated output from the LLM is validated, provide the updated output via the user interface.

17. The system of claim 15, wherein the one or more validation tests include validation tests configured to validate format of information in the output; type of information in the output; and/or business rules associated with the information in the output.

18. The system of claim 15, wherein the computer-executable instructions, when executed, further cause the one or more processors to:
automatically generate, based at least in part on the first prompt, the one or more validation tests for validating the output and the updated output from the LLM.

19. One or more non-transitory computer-readable media comprising computer-executable instructions for managing one or more models, wherein the computer-executable instructions, when executed by a computer system, cause the computer system to perform operations comprising:
receiving, via a user interface, from a user a first user input for a large language model (“LLM”);
generating, based on the first user input, a first prompt;
transmitting the first prompt to the LLM;
receiving an output from the LLM;
evaluating the output from the LLM with reference to one or more validation tests;
responsive to determining that the output from the LLM is not validated, generating a second prompt for the LLM, wherein the second prompt indicates at least an aspect of the output that caused the output to not be validated;
transmitting the second prompt to the LLM; and
receiving an updated output from the LLM.

20. The one or more non-transitory computer-readable media of claim 19, wherein the computer-executable instructions, when executed by the computer system, further cause the computer system to:
evaluate the updated output from the LLM with reference to the one or more validation tests; and
responsive to determining that the updated output from the LLM is validated, provide the updated output via the user interface.
